(19) United States
(12) Patent Application Publication
(10) Pub. No.: US 2025/0283536 A1
(43) Pub. Date: Sep. 11, 2025

(54) Valve For A Cooling System

(71) Applicant: Siemens Schweiz AG, Zürich (CH)

(72) Inventors: Pascal Ernstberger, Rastatt (DE); Grzegorz Krawiec, Ostrzesow (PL); Karl-Heinz Petry, Reichenburg (CH); Daniel Sauerer, Steinmauern (DE)

(73) Assignee: Siemens Schweiz AG, Zürich (CH)

(21) Appl. No.: 19/068,741

(22) Filed: Mar. 3, 2025

(30) Foreign Application Priority Data
Mar. 5, 2024 (EP) 24161539.2

(51) Int. Cl. F16K 1/42; F16K 1/46; F16K 31/06

(52) U.S. Cl. CPC F16K 1/42; F16K 1/465; F16K 31/0658

(57) ABSTRACT

Valve for a cooling system. A valve (1) comprising: a first port (3), a second port (4), and a fluid path extending between the ports (3, 4); a plunger (5) situated in the fluid path, the plunger (5) being selectively and linearly movable between a closed position which closes the fluid path and an open position which opens the fluid path between the first port (3) and the second port (4); a valve seat assembly (6) situated in the fluid path between the first port (3) and the second port (4), the valve seat assembly (6) comprising: a gasket (12), a frame (13) having a seat (15), and an adaptor (14a-14e); wherein the gasket (12) is different from the adaptor (14a-14e) and is different from the seat (15) and is interposed between the adaptor (14a-14e) and the seat (15).

### CROSS-REFERENCE TO RELATED APPLICATIONS

This application claims priority to EP Application Serial No. 24161539.2 filed Mar. 5, 2024, the contents of which are hereby incorporated by reference in their entirety.

### TECHNICAL FIELD

The present disclosure relates to cooling systems. Some embodiments of the teachings herein include valves for controlling a flow of a medium passing through a pipe part of a pipe system.

### BACKGROUND

Some pipe systems distribute a medium to a plurality of consumer devices and/or thermal energy exchangers. The cooling system can comprise a common source and the pipe system can connect to the common source. In commercial and/or industrial and/or residential buildings, several applications are known which make use of a pipe system. The pipe system distributes a medium to various consumer devices spread over the building. The medium typically originates from a common source.

A pipe system may be or comprise a closed circuit. The closed circuit comprises one or more supply pipes connecting the common source with each of the consumer devices. The closed circuit also comprises one or more return pipes connecting each of the consumer devices back to the common source. The consumer devices may comprise thermal energy exchangers. More specifically, the consumer devices can comprise cold exchange systems.

The pipe system may also be or comprise an open circuit. The open circuit comprises one or more supply pipes connecting the common source with each of the consumer devices. In contrast to closed circuits, there is no return pipe that connects every consumer device back to the common source.

A pipe system can be a combination of a closed circuit and an open circuit. These systems can include valves such as control valves having adjustable orifice systems for controlling the flow of a medium to the respective consumer device. The position of an adjustable orifice of the adjustable orifice system determines the amount of medium passing through the consumer device per time unit. In cold exchange applications, this means that the position of the orifice determines the amount of cooling delivered from the thermal energy exchanger to an adjacent structure. The adjacent structure may comprise an adjacent room of a building. The adjacent structure can also comprise an adjacent appliance or a space thereof.

The flow rate of a medium passing through the consumer device depends, among other factors, on the adjustable orifice. The adjustable orifice of a valve such as an expansion valve comprises a valve seat and a valve element such as a plunger. Known adjustable orifices comprise ball-type adjustable orifices and orifices of globe valves.

An adjustable orifice of a valve functions to enable flow through the valve when the adjustable orifice is in an open position. An adjustable orifice of a valve functions to obturate flow through the valve when the adjustable orifice is in a closed position. In certain applications, the adjustable orifice is expected to close tightly when the adjustable orifice is in the closed position. In other words, in the closed position of the adjustable orifice there will be zero flow through the valve.

An adjustable orifice of a valve of a cooling system is a mechanical part and as such is prone to mechanical wear. The parts of the adjustable orifice such as the valve element and the valve seat are expected to not leak even after many valve cycles. Those parts of the adjustable orifice are also expected to not leak after several years in service.

The adjustable orifice is also expected to close and/or to open a fluid path throughout the entire applicable temperature range. In cooling systems, the temperature range begins at temperatures such as 200 Kelvins or 210 Kelvins or 213 Kelvins or 220 Kelvins. The temperature range can also begin at any temperature in between the aforementioned temperatures. The temperature range ends at temperatures such as 410 Kelvins or 430 Kelvins or 433 Kelvins or 440 Kelvins. The temperature range can also end at any temperature in between the aforementioned temperatures. More specifically, temperature ranges can begin at 213 Kelvins and can end at 433 Kelvins. Temperature ranges can also begin at 210 Kelvins and end at 440 Kelvins. Temperature ranges can still begin at 220 Kelvins and end at 430 Kelvins.

Patent U.S. Pat. No. 6,435,207B1 deals with a flow regulation fitting in a control system for pipe systems. The patent describes a flow regulation control valve for setting and measuring volume flow in pipes. The flow regulation control valve comprises a shut-off member arranged in a flow chamber, for setting a desired flow state. A sensor is arranged in or adjacent the flow chamber, for sensing a value representative of a flow through the flow chamber.

The flow regulation control valve further comprises an evaluation unit. The evaluation unit determines the flow from the signal recorded by the sensor and from the characteristic values of the control valve. Those characteristic values are stored in an electronic data store at the sensor and are valve specific. A flow rate through a section of the pipe system is manually adjusted using the shut-off member of the flow regulation control valve. The flow rate is adjusted until the desired flow is displayed by the evaluation unit. One or more seals prevent escape of a medium through a bore of the valve of U.S. Pat. No. 6,435,207B1.

A patent application W098/25086A1 discloses a modulating fluid control device for a fluid-based heating and cooling system for a measured environment. The control device comprises a body, a supply port and a return port and a valve located between these ports. A plug of the valve connects to an actuator. The actuator and the plug are responsive to input from a sensor and from a controller. The flow of a medium through the valve is thereby restricted, the restriction depending on conditions in the measured environment. The control device is provided with a valve controller and an actuator to position the valve and thereby regulate flow through that valve. A flow sensor is associated with the valve and records the flow of the medium at a location in the system. The flow sensor provides a signal indicative of that flow rate to the valve controller. The flow sensor and the valve controller maintain a required flow rate through the system as recorded by the sensor. The system thereby promotes desired environmental conditions in a space.

A European patent application EP3839308A1 deals with an expansion valve. The valve comprises an inlet port, an outlet port, and an adjustable orifice situated in a fluid path between the inlet port and the outlet port. The adjustable orifice system corresponds to a globe valve and comprises the adjustable orifice and an armature. An electric current through a solenoid causes movement of the armature and of the adjustable orifice. The solenoid is directly immersed in a refrigerant.

A patent U.S. Pat. No. 5,419,365A discloses a valve having a replaceable cartridge. An adaptor fitting secures the replaceable cartridge to the body of the valve. A plunger of the valve engages a valve element of the replaceable cartridge. A seal is arranged between the valve member and the seat member of the valve of U.S. Pat. No. 5,419,365A. The seal prevents leakage.

A patent U.S. Pat. No. 5,730,423A deals with an all metal diaphragm valve. The valve of U.S. Pat. No. 5,730,423A comprises a valve chamber having a toroidal bead. In the closed position, the bead abuts a diaphragm of the valve, the diaphragm being arranged in between the bead and an actuator.

### SUMMARY

The present disclosure deals with a valve for a cooling system wherein the adjustable orifice of the valve is improved. The valve can, by way of example, be an expansion valve in the cooling system. For example, some embodiments include a valve (1) comprising: an adaptor (14a-14e), a first port (3), a second port (4), and a fluid path extending between the first port (3) and the second port (4); a plunger (5) situated in the fluid path between the first port (3) and the second port (4), the plunger (5) being selectively and linearly movable between a closed position which closes the fluid path between the first port (3) and the second port (4) and an open position which opens the fluid path between the first port (3) and the second port (4); a valve seat assembly (6) situated in the fluid path between the first port (3) and the second port (4), the valve seat assembly (6) comprising: a gasket (12) and a frame (13), the frame (13) having a seat (15); wherein the gasket (12) is different from the adaptor (14a-14e) and is different from the seat (15) and is interposed between the adaptor (14a-14e) and the seat (15); wherein the adaptor (14a-14e) has a first aperture, the first aperture having a first diameter and wherein the gasket (12) has a second aperture, the second aperture having a second diameter; wherein the first diameter is larger than the second diameter; wherein in the open position the plunger (5) is detached from the gasket (12) to enable a flow of a fluid through the second aperture and along the fluid path; wherein in the closed position the plunger (5) abuts the gasket (12) to prevent the flow of the fluid through the second aperture and along the fluid path; wherein the seat (15) comprises a seat surface; and wherein at least one first protrusion (18a, 18b; 19a, 19b; 20a, 20b) projects from the seat surface and imbeds itself into the gasket (12).

In some embodiments, the at least one first protrusion (18a, 18b; 19a, 19b; 20a, 20b) comprises at least one of: a first edge (18a, 18b; 19a, 19b; 20a, 20b), a first, annular edge (18a, 18b; 19a, 19b; 20a, 20b), a first, circular edge (18a, 18b; 19a, 19b; 20a, 20b), a first rim (18a, 18b; 19a, 19b; 20a, 20b), a first, annular rim (18a, 18b; 19a, 19b; 20a, 20b), and a first, circular rim (18a, 18b; 19a, 19b; 20a, 20b).

In some embodiments, the at least one first protrusion (18a, 18b; 19a, 19b; 20a, 20b) projects at least 0.2 millimetres from the surface of the seat (15).

In some embodiments, the at least one first protrusion (18a, 18b; 19a, 19b; 20a, 20b) is formed in the surface of the seat (15).

In some embodiments, the at least one first protrusion (18a, 18b; 19a, 19b; 20a, 20b) comprises an end pointing toward the gasket (12);

wherein the at least one first protrusion (18a, 18b; 19a, 19b; 20a, 20b) tapers toward its end at an obtuse angle; and

wherein the obtuse angle is between 105° and 150°.

In some embodiments, the surface of the seat (15) comprises a first portion (16a, 16b; 17a, 17b) and wherein the surface of the gasket (12) comprises a first portion; wherein the first portion (16a, 16b; 17a, 17b) of the surface of the seat (15) and the first portion of the surface of the gasket (12) are each substantially perpendicular to an axis defined by a linear movement of the plunger (5); and wherein the first portion (16a, 16b; 17a, 17b) of the surface of the seat (15) abuts the first portion of the surface of the gasket (12).

In some embodiments, the first portion (16a, 16b; 17a, 17b) of the surface of the seat (15) is flat; and the first portion of the surface of the gasket (12) is flat.

In some embodiments, the first portion (16a, 16b; 17a, 17b) of the surface of the seat (15) is substantially parallel to the first portion of the surface of the gasket (12).

In some embodiments, the surface of the seat (15) comprises a second portion (17a, 17b; 16a, 16b) and wherein the surface of the gasket (12) comprises a second portion; the second portion (17a, 17b; 16a, 16b) of the surface of the seat (15) is different from the first portion (16a, 16b; 17a, 17b) of the surface of the seat (15); the second portion of the surface of the gasket (12) is different from the first portion of the surface of the gasket (12); the second portion (17a, 17b; 16a, 16b) of the surface of the seat (15) and the second portion of the surface of the gasket (12) are each substantially perpendicular to an or to the axis defined by a or by the linear movement of the plunger (5); and the second portion (17a, 17b; 16a, 16b) of the surface of the seat (15) abuts the second portion of the surface of the gasket (12).

In some embodiments, the second portion (17a, 17b; 16a, 16b) of the surface of the seat (15) is flat; and the second portion of the surface of the gasket (12) is flat.

In some embodiments, the second portion (17a, 17b; 16a, 16b) of the surface of the seat (15) is substantially parallel to the second portion of the surface of the gasket (12).

In some embodiments, the at least one first protrusion (18a, 18b; 19a, 19b; 20a, 20b) is interposed between the first portion (16a, 16b; 17a, 17b) of the surface of the seat (15) and the second portion (17a, 17b; 16a, 16b) of the surface of the seat (15).

In some embodiments, the at least one first protrusion (18a, 18b; 19a, 19b; 20a, 20b) and the first portion (16a, 16b; 17a, 17b) of the surface of the seat (15) and the second portion (17a, 17b; 16a, 16b) of the surface of the seat (15) have rotational symmetry about the axis defined by the linear movement of the plunger (5).

In some embodiments, the first portion (16a, 16b; 17a, 17b) of the surface of the seat (15) and the first portion of the surface of the gasket (12) and the second portion (17a, 17b; 16a, 16b) of the surface of the seat (15) and the second portion of the surface of the gasket (12) are substantially parallel to one another.

In some embodiments, at least one second protrusion (19a, 19b; 20a, 20b) projects from the seat surface and imbeds itself into the gasket (12); and the at least one second protrusion (19a, 19b; 20a, 20b) is different from the at least one first protrusion (18a, 18b; 19a, 19b; 20a, 20b).

### BRIEF DESCRIPTION OF THE DRAWINGS

Various features are apparent to those skilled in the art from the following detailed description of the disclosed non-limiting embodiments. The drawings that accompany the detailed description can be briefly described as follows:

FIG. 1 is a schematic of a valve incorporating teachings of the present disclosure in a valve for a cooling circuit;

FIG. 2 depicts details of the valve seat assembly of the valve shown in FIG. 1;

FIG. 3 shows details of the valve seat of the valve seat assembly of FIG. 1;

FIG. 4 illustrates details of the edge and/or of the rim of the valve of FIG. 1; and

FIG. 5 shows an assembly with more than one edge and/or with more than one rim.

### DETAILED DESCRIPTION

The teachings of the present disclosure include an adjustable orifice of a valve including a valve member in the form of a plunger. The adjustable orifice also comprises a valve seat assembly having a valve seat in the form of a gasket. The plunger cooperates with the gasket to close and to open the valve. More specifically, the plunger in the closed position abuts the gasket. In the open position, the plunger is detached from the gasket.

The tip end of the plunger has the shape of a receptacle with a head portion pointing toward the gasket. An edge is provided at end of the head. In the closed position, the edge abuts the gasket thereby closing the valve.

The plunger and the gasket can be made of materials that provide longevity. For example, the plunger can be made of a metal such as (stainless) steel whereas the gasket is made of a polymeric material. The material of the gasket is generally more ductile than the material of the (circular edge of the) plunger.

To arrive at a more versatile solution, an adaptor such as a flow control adaptor may be employed. The adaptor is part of the valve seat assembly. That is, different adaptors can be used in a valve that remains otherwise unchanged.

While the valve member and/or the plunger are moving parts, the gasket is not configured to move during operation of the valve. Like the gasket, the adaptor provides an aperture and/or a bore for enabling a flow of a fluid between the ports of the valve. The fluid can be a refrigerant fluid. It can be liquid and/or gaseous. The fluid can also be superheated.

The gasket is mounted on a seat surface of the seat assembly. That is, a surface of the gasket abuts the seat surface. A rim such as a circular rim projects from the seat surface. The seat surface is smooth except for the rim projecting from the seat surface, the seat surface and the rim being unitary. More specifically, the seat surface is smooth except for the circular rim projecting from the seat surface, the seat surface and the circular rim being unitary.

When the gasket is pressed against the rim, the gasket is deformed. An annular groove is formed in the gasket and the projecting rim fits in the annular groove. The gasket is pressed against the projecting rim such that the rim imbeds itself in the gasket. More specifically, a circular rim projecting from the seat surface imbeds itself in the gasket. Hence, the arrangement becomes fluid tight, and the rim retains the gasket. The rim retains the gasket even when a temperature of a refrigerant in the valve changes. No further gasket and no further O-ring will be required to retain the gasket.

The gasket is made of a material that is more ductile than the circular rim. The gasket is also made of a material that is more ductile than the seat surface. The gasket can, by way of non-limiting example, be made of a polymeric material. The seat surface and the rim can, by way of non-limiting example, be made of a metal such as steel or aluminum or an alloy thereof.

The rim projects from the seat surface and can comprise a circular projecting rim. The rim projects from the seat surface and can be a circular projecting rim. In some embodiments, the rim projects from the seat surface and comprises an edge such as an annular edge. In a special embodiment, the rim projects from the seat surface and is an edge such as an annular edge.

The portion of the rim or the portion of the edge that points toward the gasket can be tapered. The portion of the rim or the portion of the edge that points toward the gasket is preferably tapered at an obtuse angle. The obtuse angle can, by way of non-limiting example, exceed 105° or be 120° or be less than 135°. The obtuse angle can, by way of another non-limiting example, be substantially 120°. The angle can be between 119° and 121°.

Likewise, the portion of the circular rim or the portion of the annular edge that points toward the gasket can be tapered. The portion of the circular rim or the portion of the annular edge that points toward the gasket may be tapered at an obtuse angle.

The obtuse angle can, by way of non-limiting example, exceed 105° or be 120° or be less than 135°. The obtuse angle can, by way of another non-limiting example, be substantially 120°. The angle can be between 119° and 121°.

In some embodiments, more than one rim projects from the surface of the seat of the assembly. For example, two rims or three rims can project from the surface of the seat. These rims project from the surface of the seat toward the gasket. The seat surface and the rims projecting from the seat surface are ideally unitary. In other words, more than one rim imbeds itself into the gasket when the gasket is pressed against the seat. A plurality of grooves is thus formed in the gasket. The number of grooves in the gasket is commensurate with the number of rims projecting from the surface of the seat. Hence, the arrangement becomes even more fluid tight, and the rims retain the gasket. The rims retain the gasket even when a temperature of a refrigerant in the valve changes. No further gasket and no further O-ring will be required to retain the gasket.

In some embodiments, more than one circular rim projects from the surface of the seat of the assembly. For example, two circular rims or three circular rims can project from the surface of the seat. These circular rims project from the surface of the seat toward the gasket. The circular rims are preferably concentric. The seat surface and the circular rims projecting from the seat surface are ideally unitary. In other words, more than one circular rim imbeds itself into the gasket when the gasket is pressed against the seat. A plurality of grooves is thus formed in the gasket. The number of grooves in the gasket is commensurate with the number of circular rims projecting from the surface of the seat. Hence, the arrangement becomes even more fluid tight, and the circular rims retain the gasket. The circular rims retain the gasket even when a temperature of a refrigerant in the valve changes. No further gasket and no further O-ring will be required to retain the gasket.

In some embodiments, more than one edge projects from the surface of the seat of the assembly. For example, two edges or three edges can project from the surface of the seat. These edges project from the surface of the seat toward the gasket. The seat surface and the edges projecting from the seat surface are ideally unitary. In other words, more than one edge imbeds itself into the gasket when the gasket is pressed against the seat. A plurality of grooves is thus formed in the gasket. The number of grooves in the gasket is commensurate with the number of edges projecting from the surface of the seat. Hence, the arrangement becomes even more fluid tight, and the edges retain the gasket. The edges retain the gasket even when a temperature of a refrigerant in the valve changes. No further gasket and no further O-ring will be required to retain the gasket.

In some embodiments, more than one annular edge projects from the surface of the seat of the assembly. For example, two annular edges or three annular edges can project from the surface of the seat. These annular edges project from the surface of the seat toward the gasket. The annular edges are preferably concentric. The seat surface and the annular edges projecting from the seat surface are ideally unitary. In other words, more than one annular edge imbeds itself into the gasket when the gasket is pressed against the seat.

A plurality of grooves is thus formed in the gasket. The number of grooves in the gasket is commensurate with the number of annular edges projecting from the surface of the seat. Hence, the arrangement becomes even more fluid tight, and the annular edges retain the gasket. The annular edges retain the gasket even when a temperature of a refrigerant in the valve changes. No further gasket and no further O-ring will be required to retain the gasket.

Each portion of a rim or each portion of an edge that points toward the gasket can be tapered. The portions of the rims or the portions of the edges that point toward the gasket can be each tapered at an obtuse angle. The obtuse angle can, by way of non-limiting example, exceed 105° or be 120° or be less than 135°. The obtuse angle α can, by way of another non-limiting example, be substantially 120°:

a≈120°

The angle α can be between 119° and 121°:

119°≤α≤121°

The portions of the rims or the portions of the edges that point toward the gasket may be tapered each at substantially the same obtuse angle. The portions of the rims or the portions of the edges that point toward the gasket are ideally tapered each at substantially the same obtuse angle.

Likewise, each portion of a circular rim or each portion of an annular edge that points toward the gasket can be tapered. The portions of the circular rims or the portions of the annular edges that point toward the gasket may be tapered at an obtuse angle.

The obtuse angle can, by way of non-limiting example, exceed 105° or be 120° or be less than 135°. The obtuse angle α can, by way of another non-limiting example, be substantially 120°:

a≈120°

The angle α can be between 119° and 121°:

119°≤α≤121°

The portions of the circular rims or the portions of the annular edges pointing toward the gasket may be tapered each at substantially the same obtuse angle. The portions of the circular rims or the portions of the annular edges pointing toward the gasket are ideally tapered each at substantially the same obtuse angle.

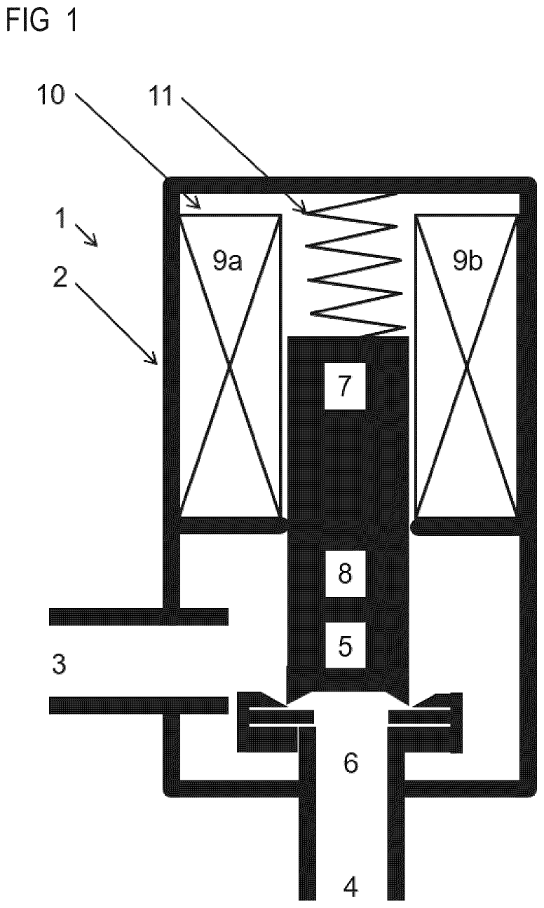

FIG. 1 shows the various components of an example valve 1 incorporating teachings of the instant disclosure. The valve 1 comprises an expansion valve. In some embodiments, the valve 1 is or comprises an electronic expansion valve. The valve 1 can be installed in a refrigeration-vapour circuit. In some embodiments, the valve 1 is part of a refrigeration-vapour circuit.

The valve 1 comprises a housing 2. The valve housing 2 has sides defining a first port 3 and a second port 4. In some embodiments, the first port 3 comprises a first conduit. In some embodiments, the second port 4 comprises a second conduit. In some embodiments, the first port 3 is an inlet port and the second port 4 is an outlet port. In some embodiments, the first port 3 is an outlet port and the second port 4 is an inlet port.

In some embodiments, a valve body is or comprises the housing 2. In some embodiments, the housing 2 comprises a metallic material such as steel, especially austenitic (stainless) steel and/or ferrite steel. In some embodiments, the housing 2 comprises aluminum (alloy) or gunmetal or brass. In some embodiments, the housing 2 comprises a polymeric material. In some embodiments, the housing 2 is manufactured using an additive manufacturing technique such as three-dimensional printing. Manufacture of the can involve selective laser sintering. In some housing 2 embodiments, the housing 2 comprises a grey cast material.

In some embodiments, the housing 2 is non-unitary. A non-unitary and/or modular housing 2 affords a valve 1 that can be adapted to various values of nominal flow.

The first port 3 and the second port 4 are in fluid communication with each other to afford flow of a fluid through the valve 1. In some embodiments, the fluid comprises a refrigerant. The fluid may, by way of non-limiting example, be a R32, R134a, R290, R410A, R450A, R452A, R513A, R454C, R1234yf, or a R1234ze (E) refrigerant. The fluid at the inlet port may be a liquid and/or a gaseous fluid. The fluid at the outlet port preferably is a two-phase fluid.

A fluid path extends between the first port 3 and the second port 4. A plunger 5 is situated in the fluid path. The plunger 5 is linearly movable. The plunger 5 can also be axially movable. The plunger 5 cooperates with a valve seat assembly 6. The plunger 5 thereby varies and limits a flow rate of the fluid through the valve 1.

The plunger 5 comprises a head portion. The head portion protrudes from the plunger 5. Ideally, the head portion protrudes from the plunger 5 in the direction of the valve seat assembly 6. In some embodiments, the plunger 5 comprises a body portion. The head portion protrudes from the body portion of the plunger 5. In some embodiments, the head portion protrudes from the body portion of the plunger 5 in the direction of the valve seat assembly 6. In some embodiments, the plunger 5 comprises a receptacle portion. The head portion protrudes from the receptacle portion of the plunger 5. In some embodiments, the head portion protrudes from the receptacle portion of the plunger 5 in the direction of the valve seat assembly 6.

The plunger 5 comprises an end pointing toward the valve seat assembly 6. The end of the plunger 5 can have the shape of a receptacle and/or of an inverted bowl. The shape of the end of the plunger 5 can be such that the opening of the receptacle points toward the valve seat assembly 6.

In some embodiments, the plunger 5 comprises an axial bore. The axial bore through the plunger 5 affords compensation of pressure within the valve 1.

In some embodiments, the head portion comprises the end pointing toward the valve seat assembly 6. The end of the plunger 5 and/or of the head portion can comprise a circular edge pointing toward the valve seat assembly 6. The edge can be a sharp edge with an acute angle. That is, the edge tapers toward the valve seat assembly 6 and that tapering defines an acute angle. The acute angle can, by way of example, be less than twenty degrees or less than ten degrees or even less than five degrees.

In some embodiments, the edge at the end of the plunger 5 comprises a rim. The edge at the end of the plunger 5 follows a closed continuous line. The edge at the end of the plunger 5 can also follow a closed continuous and circular line.

FIG. 1 shows the valve seat assembly 6 as part of the second port 4. A skilled person having reviewed the embodiments disclosed herein understands that the first port 3 can also comprise the valve seat assembly 6. The skilled person also understands that the assembly 6 can be separate from the first port 3 and can be separate from the second port 4.

In the embodiment shown in FIG. 1, the plunger 5 is linearly movable by linear movement of the armature 7. An axial direction is defined by the linear movement of the plunger 5. That is, the plunger 5 is axially movable by axial movement of the armature 7. The armature 7 can mechanically connect to the plunger 5 via a stem 8. In some embodiments, the armature 7 directly connects to the plunger 5. In some embodiments, the armature 7 and the plunger 5 are unitary.

In some embodiments, the armature 7, the stem 8, and the plunger 5 are unitary. That is, the stem 8 and the plunger 5 are both integral parts of the armature 7. Likewise, the armature 7 and the stem 8 are integral with the plunger 5.

In some embodiments, the plunger 5 is configured to rotate by some extent with respect to the armature 7. The plunger 5 preferably rotates about an axis connecting the armature 7, the plunger 5, and/or the stem 8. In some embodiments, the plunger 5 is allowed to rotate by an articulation angle of 0.1 degrees or of 0.2 degrees or even of 0.5 degrees. A limited amount of articulation of the plunger 5 with respect to the armature 7 improves on the alignment of the arrangement.

At least a portion of the armature 7 may be surrounded by a solenoid 9a, 9b. Upon application of an electric current, the solenoid 9a, 9b produces a magnetic flux. This magnetic flux acts on the armature 7 thereby displacing the armature 7.

FIG. 1 shows a valve 1 having a solenoid actuator. In some embodiments, other actuators such as hydraulic or pneumatic actuators can be used to actuate the stem 8 and the plunger 5. The valve 1 may also be actuated by a magnetic piston pump. This list of actuators is not exhaustive.

A tubular portion such as a can needs not envelop the armature 7 and/or the stem 8. That is, the armature 7 has an outer surface. In some embodiments, a portion of the outer surface of the armature 7 directly faces the solenoid 9a, 9b. In some embodiments, the outer surface of the armature 7 directly faces the solenoid 9a, 9b. Likewise, the solenoid 9a, 9b has an outer surface. In some embodiments, a portion of the outer surface of the solenoid 9a, 9b directly faces the armature 7. In another embodiment, the outer surface of the solenoid 9a, 9b directly faces the armature 7.

The solenoid 9a, 9b and the armature 7 are arranged in the same chamber 10 inside the housing 2. The chamber 10 is ideally filled with a liquid and/or with a gaseous fluid. The liquid and/or gaseous fluid inside the chamber 10 can, by way of non-limiting example, be a R32, R134a, R290, R410A, R450A, R452A, R513A, R454C, R1234yf, or a R1234ze (E) refrigerant.

This liquid and/or gaseous fluid is in direct contact with the outer surface of the portion of the armature 7 that is inside the chamber 10. The liquid and/or gaseous fluid also is in direct contact with the solenoid 9a, 9b.

In some embodiments, the solenoid 9a, 9b comprises a plurality of coils. In some embodiments, at least one coil or at least two coils or at least five coils of the solenoid 9a, 9b are directly exposed to the liquid and/or to the gaseous fluid in the chamber 10a. In some embodiments, all the coils of the solenoid 9a, 9b are directly exposed to the liquid and/or to the gaseous fluid. The solenoid 9a, 9b preferably comprises a helical solenoid.

FIG. 1 shows a solenoid 9a, 9b comprising two parts. In some embodiments, the two parts of the solenoid 9a, 9b electrically form a single solenoid 9a, 9b. That is, the two parts 9a, 9b of the solenoid are galvanically connected.

A resilient member 11 ensures that the valve 1 is a normally closed valve. The resilient member 11 couples to the armature 7. In some embodiments, the resilient member 11 mechanically connects to the armature 7.

The resilient member 11 urges the armature 7 and the plunger 5 to close the valve 1. To that end, the resilient member 11 urges the armature 7 and the plunger 5 toward the seat assembly 6. In some embodiments, the resilient member 11 urges the armature 7, the stem 8, and the plunger 5 to close the valve 1. To that end, the resilient member 11 urges the armature 7, the stem 8, and the plunger 5 toward the seat assembly 6. The member 11 preferably urges these movable members 7, 8, 5 toward the assembly 6 until the plunger 5 engages a cooperating member of the assembly 6. The plunger 5 engages the cooperating member of the assembly 6 in the closed position of the valve 1.

In some embodiments, the resilient member 11 comprises a compression spring. In some embodiments, the resilient member 11 comprises a helical compression spring.

FIG. 1 shows a resilient member 11 in the form of a spring. In some embodiments, other resilient members such as ferromagnetic members urge the armature 7 and the plunger 5 to close the valve 1. In some embodiments, resilient members such as ferromagnetic members urge the armature 7, the stem 8, and the plunger 5 to close the valve 1. This list of resilient members is not exhaustive.

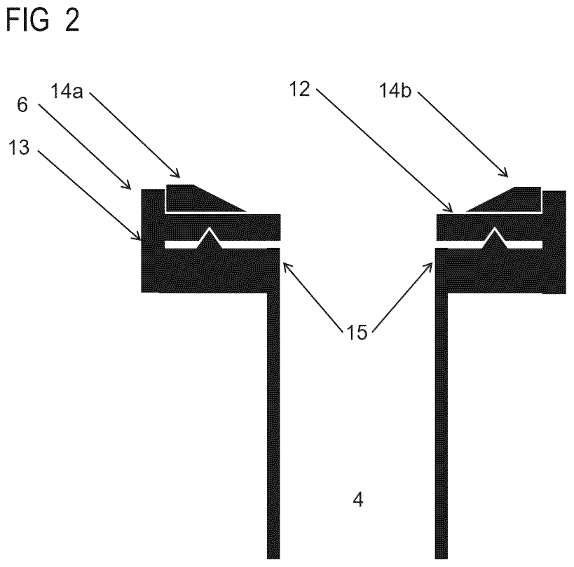

Now turning to FIG. 2, details of the valve seat assembly 6 of the valve 1 are shown. The valve seat assembly 6 comprises a gasket 12 such as an annular seal. The gasket 12 can be made of an elastic material such as a polymeric material and/or a rubber material. The gasket 12 can, by way of non-limiting examples, be made of a polymeric material comprising at least one of:
polytetrafluoroethylene,
polyether ether ketone.

The polymeric material comprising polytetrafluoroethylene can also comprise graphite particles such as nodular graphite.

The gasket 12 can, by way of other non-limiting examples, be made of a polymeric material selected from:
polytetrafluoroethylene or
polyether ether ketone.

The gasket 12 provides an aperture to enable a flow of a fluid toward or from the first port 3. Likewise, the gasket 12 provides an aperture to enable a flow of a fluid toward or from the second port 4. In other words, the gasket 12 forms a hollow disk.

The aperture and/or the orifice of the gasket 12 is such that the plunger 5 cannot move into and out of the aperture and/or orifice of the gasket 12. In other words, the gasket 12 will eventually stop or inhibit movements of the plunger 5. That is, an inner diameter of the aperture and/or of the orifice of the gasket 12 is less than an outer diameter of the plunger 5. More specifically, the inner diameter of the aperture and/or of the orifice can be less than the outer diameter of the edge of the plunger 5. The inner diameter of the aperture and/or of the orifice can also be less than the outer diameter of the rim of the plunger 5. The inner diameter of the aperture and/or of the orifice can still be less than the outer diameter of the head portion of the plunger 5.

In some embodiments, the gasket 12 has cylindrical symmetry. In some embodiments, the second port 4 has cylindrical symmetry. In some embodiments, the gasket 12 and the second port 4 both have cylindrical symmetry. The gasket 12 and the second port 4 can even exhibit cylindrical symmetry with respect to the same axis or with respect to substantially the same axis. This axis is defined by the linear movement of the plunger 5. This axis can also be defined by the axial movement of the plunger 5.

In some embodiments, the gasket 12 and the aperture of the gasket 12 both have cylindrical symmetry. The gasket 12 and the aperture of the gasket 12 can even exhibit cylindrical symmetry with respect to the same axis or to substantially the same axis. This axis is defined by the linear movement of the plunger 5. This axis can also be defined by the axial movement of the plunger 5.

The gasket 12 can be mechanically mounted to a frame 13. The gasket 12 can also be mounted to a seat 15 of the assembly 6. In some embodiments, the gasket 12 is mounted to a seat 15 of the frame 13. In some embodiments, the frame 13 and the seat 15 are unitary.

In some embodiments, the frame 13 and/or the seat 15 mechanically connect the gasket 12 to the second port 4. In some embodiments, the seat 15 and the gasket 12 provide parallel surfaces. These parallel surfaces are perpendicular to a direction of flow through the second port 4 and/or to a symmetry axis of the second port 4. These parallel surfaces are also each perpendicular to an axial direction defined by the (movement of the) plunger 5. In some embodiments, the parallel surface of the gasket 12 abuts the parallel surface of the seat 15. That is, the gasket 12 sits on the seat 15.

In some embodiments, the frame 13 comprises a metallic material such as steel, especially austenitic (stainless) steel and/or ferrite steel. In some embodiments, the frame 13 comprises aluminum (alloy) or gunmetal or brass. In some embodiments, the frame 13 comprises a polymeric material. In some embodiments, the frame 13 is manufactured using an additive manufacturing technique such as three-dimensional printing. Manufacture of the frame 13 can, in a specific embodiment, involve selective laser sintering. In some embodiments, the frame 13 comprises a grey cast material.

In some embodiments, the housing 2 and the frame 13 are made of the same materials. In some embodiments, the housing 2 and the frame 13 are unitary. When the housing 2 and the frame 13 form a single piece, the number of parts of the valve 1 can be lowered. Consequently, there are fewer parts that are prone to failure.

In some embodiments, the seat 15 comprises a metallic material such as steel. The steel material can, by way of non-limiting example, be selected from:
austenite steel,
ferrite steel,
stainless steel.

In some embodiments, the seat 15 comprises aluminum (alloy) or gunmetal or brass. In some embodiments, the seat 15 comprises a polymeric material. In some embodiments, the seat 15 is manufactured using an additive manufacturing technique such as three-dimensional printing. Manufacture of the seat 15 can, in a specific embodiment, involve selective laser sintering. In some embodiments, the seat 15 comprises a grey cast material.

In some embodiments, the frame 13 and the seat 15 each comprise a metallic material such as steel. The steel material can, by way of non-limiting example, be selected from:
austenite steel,
ferrite steel,
stainless steel.

In some embodiments, the frame 13 and the seat 15 each comprise aluminum (alloy) or gunmetal or brass. In some embodiments, the frame 13 and the seat 15 each comprise a polymeric material. In some embodiments, the frame 13 and the seat 15 are manufactured using an additive manufacturing technique such as three-dimensional printing. Manufacture of the frame 13 and of the seat 15 can, in a specific embodiment, involve selective laser sintering. In some embodiments, the frame 13 and the seat 15 each comprise a grey cast material.

The valve seat assembly 6 also comprises a flow control adaptor 14a, 14b. The flow control adaptor 14a, 14b is arranged such that the gasket 12 is arranged in between the flow control adaptor 14a, 14b and the valve port 4. In some embodiments, the gasket 12 is arranged in between the flow control adaptor 14a, 14b and (the aforementioned parallel surface of) the seat 15.

The flow control adaptor 14a, 14b can be mechanically mounted to a frame 13. The frame 13 thus mechanically connects the flow control adaptor 14a, 14b to the second port 4. In some embodiments, the flow control adaptor 14a, 14b and the gasket 12 provide parallel surfaces. These parallel surfaces are perpendicular to a direction of flow through the second port 4 and/or to a symmetry axis of the second port 4. These parallel surfaces are also each perpendicular to an axial direction defined by the (linear movement of the) plunger 5. These parallel surfaces are still each perpendicular to an axial direction defined by the (axial movement of the) plunger 5. In some embodiments, the parallel surface of the gasket 12 abuts the parallel surface of the flow control adaptor 14a, 14b.

In some embodiments, the flow control adaptor 14a, 14b and the plunger 5 are unitary. The number of parts of the valve 1 is thereby reduced. This results in a valve 1 that is more robust because there are fewer parts that are prone to failure. That is, the gasket 12 has a first surface and a second surface, the second surface being different from the first surface. The second surface and the first surface of the gasket 12 are parallel. The first surface of the gasket 12 and the second surface of the gasket 12 are disposed on opposite sides of the gasket 12. The first surface of the gasket 12 faces and/or abuts the seat 15. The second surface of the gasket 12 faces and/or abuts the flow control adaptor 14a, 14b. The gasket 12 is squeezed in between the (a portion of the) seat 15 and the flow control adaptor 14a, 14b. In the closed position, the second surface of the gasket 12 also abuts the plunger 5 and/or the head portion of the plunger 5.

In operation, the gasket 12 can cooperate with the plunger 5 to close or open the valve 1. More specifically, the gasket 12 cooperates with a cooperating portion of the plunger 5. The cooperating portion of the plunger 5 can be selected from at least one of:
the edge of the plunger 5,
the rim of the plunger 5,
the head portion of the plunger 5.

The gasket 12 can be made of a material that is more ductile than the material of the cooperating portion of the plunger 5. The material of the gasket 12 at temperatures below 433 Kelvins is more ductile than the material of the aforementioned cooperating portion. The material of the gasket 12 is also more ductile than the material of the cooperating portion at temperatures above 213 Kelvins. In other words, the gasket 12 may be deformed while the valve 1 is in service.

In some embodiments, the flow control adaptor 14a, 14b comprises aluminum (alloy) or gunmetal or brass. In some embodiments, the flow control adaptor 14a, 14b comprises a polymeric material. The material of the flow control adaptor 14a, 14b can, by way of non-limiting example, also be selected from:
austenite steel,
ferrite steel,
stainless steel.

The flow control adaptor 14a, 14b provides an aperture and/or an orifice to enable a flow of a fluid toward or from the first port 3. Likewise, the flow control adaptor 14a, 14b provides an aperture and/or an orifice to enable a flow of a fluid toward or from the second port 4. The aperture and/or the orifice of the adaptor 14a, 14b affords linear movement of the plunger 5 into and out of the aperture and/or the orifice. The aperture and/or the orifice of the adaptor 14a, 14b also affords axial movement of the plunger 5 into and out of the aperture and/or the orifice. That is, an inner diameter of the aperture and/or of the orifice of the adaptor 14a, 14b is larger than an outer diameter of the plunger 5. More specifically, the inner diameter of the aperture and/or of the orifice can be larger than the outer diameter of the edge of the plunger 5. The inner diameter of the aperture and/or of the orifice can also be larger than the outer diameter of the rim of the plunger 5. The inner diameter of the aperture and/or of the orifice can still be larger than the outer diameter of the head portion of the plunger 5.

In some embodiments, the plunger 5 can linearly move a distance between zero and ten millimetres in the direction of flow. More preferably, the plunger 5 can linearly move a distance between zero and five millimetres in the direction of flow. In some embodiments, the plunger 5 can linearly move a distance between zero and three millimetres in the direction of flow. Small travel distances of the plunger 5 result in a valve 1 that requires modest resources in terms of actuation.

In some embodiments, the plunger 5 can axially move a distance between zero and ten millimetres in the direction of flow. In some embodiments, the plunger 5 can axially move a distance between zero and five millimetres in the direction of flow. In some embodiments, the plunger 5 can axially move a distance between zero and three millimetres in the direction of flow. Small travel distances of the plunger 5 result in a valve 1 that requires modest resources in terms of actuation.

The flow control adaptor 14a, 14b forms a part that is different from the frame 13 and is different from the gasket 12. The flow control adaptor 14a, 14b also forms a part that is different from the seat 15. The flow control adaptor 14a, 14b can even be mechanically separable from the frame 13 and from the gasket 12.

The flow control adaptor 14a, 14b can also be mechanically separable from the seat 15. These separations preferably take place non-destructively. That is, various flow control adaptors 14a, 14b can be used together with the same frame 13 and together with the same gasket 12. Various flow control adaptors 14a, 14b can also be used together with the same seat 15. More specifically, various flow control adaptors 14a, 14b can be mounted to and/or fitted to the same frame 13. For example, various flow control adaptors 14a, 14b can be screw-mounted and/or glued shrink-fitted to the frame 13. Various flow control adaptors 14a, 14b can, by way of another non-limiting example, be interference-fitted to the frame 13. Various flow control adaptors 14a, 14b can, by way of still another non-limiting example, be caulked to the frame 13. When various flow control adaptors 14a, 14b can be mounted to the same frame 13, the valve 1 can be configured more easily. A plethora of flow rates through the valve can be accomplished by modifying and/or by changing the flow control adaptor 14a, 14b.

In the embodiment shown in FIG. 1 and in FIG. 2, the flow control adaptor 14a, 14b is a diffuser and has rotational symmetry. The flow control adaptor 14a, 14b as shown in FIG. 1 comprises an inner portion and that inner portion has a bevelled surface. The surface of the inner portion preferably is bevelled and at the same time smooth. In some embodiments, the cooperating portion of the plunger 5 has rotational symmetry. In some embodiments, the flow control adaptor 14a, 14b and the cooperating portion of the plunger 5 both have rotational symmetry. It is also envisaged that the rim of the cooperating portion of the plunger 5 has rotational symmetry. In some embodiments, the flow control adaptor 14a, 14b and the rim of the cooperating portion of the plunger 5 both have rotational symmetry. In some embodiments, the edge of the cooperating portion of the plunger 5 has rotational symmetry. In some embodiments, the flow control adaptor 14a, 14b and the edge of the cooperating portion of the plunger 5 both have rotational symmetry. In some embodiments, the head portion of the plunger 5 has rotational symmetry. In some embodiments, the flow control adaptor 14a, 14b and the head portion of the plunger 5 both have rotational symmetry.

The flow control adaptor 14a, 14b and the cooperating portion of the plunger 5 can even exhibit rotational symmetry about (substantially) the same axis. The flow control adaptor 14a, 14b and the rim of the cooperating portion of the plunger 5 can still exhibit rotational symmetry about (substantially) the same axis. The flow control adaptor 14a, 14b and the edge of the cooperating portion of the plunger 5 can still exhibit rotational symmetry about (substantially) the same axis. In an embodiment, the flow control adaptor 14a, 14b and the head portion of the plunger 5 exhibit rotational symmetry about (substantially) the same axis. These axes are defined by the linear movement of the plunger 5. These axes can also be defined by the axial movement of the plunger 5.

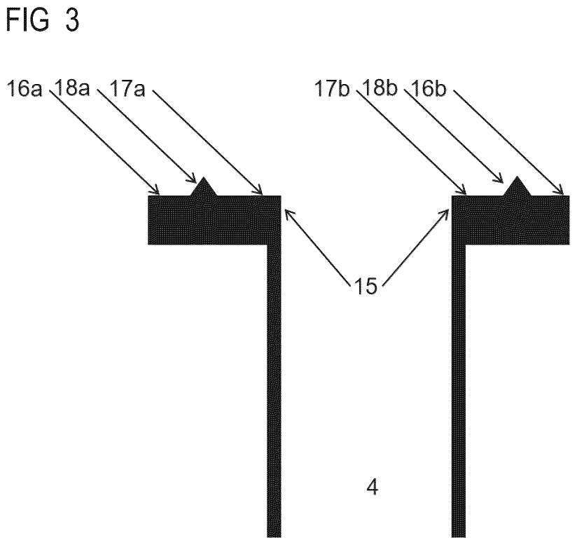

Now turning to FIG. 3, a configuration of the seat 15 of the assembly 6 is shown in detail. The seat 15 comprises a seat surface pointing toward the gasket 12. The gasket 12 of the assembly 6 is shown in FIG. 2. The seat surface comprises a first flat portion 16a, 16b and/or a first smooth portion 16a, 16b. The first flat portion 16a, 16b and/or the first smooth portion 16a, 16b faces the first surface of the gasket 12. The first flat portion 16a, 16b and/or the first smooth portion 16a, 16b of the seat surface is parallel to the first surface of the gasket 12. The first flat portion 16a, 16b and/or the first smooth portion 16a, 16b can abut the first surface of the gasket 12.

In some embodiments, the first flat portion 16a, 16b of the surface of the seat 15 comprises an outer portion 16a, 16b of the surface of the seat 15. In some embodiments, the first flat portion 16a, 16b of the surface of the seat 15 is an outer portion 16a, 16b of the surface of the seat 15. In some embodiments, the first smooth portion 16a, 16b of the surface of the seat 15 comprises an outer portion 16a, 16b of the surface of the seat 15. In some embodiments, the first smooth portion 16a, 16b of the surface of the seat 15 is an outer portion 16a, 16b of the surface of the seat 15.

In some embodiments, the first flat portion 16a, 16b of the surface of the seat 15 has rotational symmetry. In some embodiments, the first flat portion 16a, 16b and the flow control adaptor 14a, 14b and the head portion of the plunger 5 have rotational symmetry. The flow control adaptor 14a, 14b and the first flat portion 16a, 16b can exhibit rotational symmetry about substantially the same axis. The flow control adaptor 14a, 14b and the first flat portion 16a, 16b can even exhibit rotational symmetry about the same axis. The plunger 5 and the first flat portion 16a, 16b can exhibit rotational symmetry about substantially the same axis. The plunger 5 and the first flat portion 16a, 16b can even exhibit rotational symmetry about the same axis. These axes are defined by the linear movement of the plunger 5. These axes can also be defined by the axial movement of the plunger 5.

In some embodiments, the first smooth portion 16a, 16b of the surface of the seat 15 has rotational symmetry. In some embodiments, the first smooth portion 16a, 16b and the flow control adaptor 14a, 14b and the head portion of the plunger 5 have rotational symmetry. The flow control adaptor 14a, 14b and the first smooth portion 16a, 16b can exhibit rotational symmetry about substantially the same axis. The flow control adaptor 14a, 14b and the first smooth portion 16a, 16b can even exhibit rotational symmetry about the same axis. The plunger 5 and the first smooth portion 16a, 16b can exhibit rotational symmetry about substantially the same axis. The plunger 5 and the first smooth portion 16a, 16b can even exhibit rotational symmetry about the same axis. These axes are defined by the linear movement of the plunger 5. These axes can also be defined by the axial movement of the plunger 5.

The seat surface also comprises a second flat portion 17a, 17b and/or a second smooth portion 17a, 17b. The first flat portion 16a, 16b is different from the second flat portion 17a, 17b. The first smooth portion 16a, 16b is different from the second smooth portion 17a, 17b. The second flat portion 17a, 17b and/or the second smooth portion 17a, 17b faces the first surface of the gasket 12. The second flat portion 17a, 17b and/or the second smooth portion 17a, 17b of the seat surface is advantageously parallel to the first surface of the gasket 12. The second flat portion 17a, 17b and/or the second smooth portion 17a, 17b can abut the first surface of the gasket 12.

In some embodiments, the second flat portion 17a, 17b of the surface of the seat 15 comprises an inner portion 17a, 17b of the surface of the seat 15. In some embodiments, the second flat portion 17a, 17b of the surface of the seat 15 is an inner portion 17a, 17b of the surface of the seat 15. In an embodiment, the second smooth portion 17a, 17b of the surface of the seat 15 comprises an inner portion 17a, 17b of the surface of the seat 15. In some embodiments, the second smooth portion 17a, 17b of the surface of the seat 15 is an inner portion 17a, 17b of the surface of the seat 15.

In some embodiments, the second flat portion 17a, 17b of the surface of the seat 15 has rotational symmetry. In some embodiments, the second flat portion 17a, 17b and the flow control adaptor 14a, 14b and the head portion of the plunger 5 have rotational symmetry. The flow control adaptor 14a, 14b and the second flat portion 17a, 17b can exhibit rotational symmetry about substantially the same axis. The flow control adaptor 14a, 14b and the second flat portion 17a, 17b can even exhibit rotational symmetry about the same axis. The plunger 5 and the second flat portion 17a, 17b can rotational exhibit symmetry about substantially the same axis. The plunger 5 and the second flat portion 17a, 17b can even exhibit rotational symmetry about the same axis. These axes are defined by the linear movement of the plunger 5. These axes can also be defined by the axial movement of the plunger 5.

The second flat portion 17a, 17b is closer to this symmetry axis than the first flat portion 16a, 17b. The second smooth portion 17a, 17b is closer to this symmetry axis than the first smooth portion 16a, 17b.

In some embodiments, the second smooth portion 17a, 17b of the surface of the seat 15 has rotational symmetry. In some embodiments, the second smooth portion 17a, 17b and the flow control adaptor 14a, 14b and the head portion of the plunger 5 have rotational symmetry. The flow control adaptor 14a, 14b and the second smooth portion 17a, 17b can exhibit rotational symmetry about substantially the same axis. The flow control adaptor 14a, 14b and the second smooth portion 17a, 17b can even exhibit rotational symmetry about the same axis. The plunger 5 and the second smooth portion 17a, 17b can exhibit rotational symmetry about substantially the same axis. The plunger 5 and the second smooth portion 17a, 17b can even exhibit rotational symmetry about the same axis. Thes axes are defined by the linear movement of the plunger 5. Thes axes can also be defined by the axial movement of the plunger 5.

A first rim 18a, 18b such as a first, circular rim projects from the seat 15 and/or the surface of the seat 15. The seat surface is smooth except for the first rim 18a, 18b projecting from the seat surface, the seat surface and the first rim 18a, 18b being unitary. More specifically, the seat surface is smooth except for the first, circular rim 18a, 18b projecting from the seat surface, the seat surface and the first, circular rim being unitary. The seat surface can be flat except for the first, circular rim 18a, 18b projecting from the seat surface.

The first rim 18a, 18b may be arranged in between the first flat portion 16a, 16b and the second flat portion 17a, 17b. The first rim 18a, 18b can also be arranged in between the first smooth portion 16a, 16b and the second smooth portion 17a, 17b. More specifically, the first, circular rim 18a, 18b is arranged in between the first flat portion 16a, 16b and the second flat portion 17a, 17b. The first, circular rim 18a, 18b can also be arranged in between the first smooth portion 16a, 16b and the second smooth portion 17a, 17b.

In some embodiments, the first rim 18a, 18b projecting from the surface of the seat 15 has rotational symmetry. In some embodiments, the first rim 18a, 18b and the flow control adaptor 14a, 14b and the head portion of the plunger 5 have rotational symmetry. The flow control adaptor 14a, 14b and the first rim 18a, 18b can exhibit rotational symmetry about substantially the same axis. The flow control adaptor 14a, 14b and the first rim 18a, 18b can even exhibit rotational symmetry about the same axis. The plunger 5 and the first rim 18a, 18b can exhibit rotational symmetry about substantially the same axis. The plunger 5 and the first rim 18a, 18b can even exhibit rotational symmetry about the same axis. These axes are defined by the linear movement of the plunger 5. These axes can also be defined by the axial movement of the plunger 5.

In some embodiments, the first rim 18a, 18b projects between 0.1 millimetres and 0.5 millimetres from the surface of the seat 15. That is, the first rim 18a, 18b has an end pointing toward the gasket 12. A minimum distance between the end of the first rim 18a, 18b and the surface of the seat 15 is between 0.1 millimetres and 0.5 millimetres. In some embodiments, the first rim 18a, 18b projects 0.2 millimetres or 0.3 millimetres from the surface of the seat 15. That is, the first rim 18a, 18b has an end pointing toward the gasket 12. A minimum distance between the end of the first rim 18a, 18b and the surface of the seat 15 is 0.2 millimetres or 0.3 millimetres. As the first rim 18a, 18b projects further from the surface of the seat 15, the retention of the gasket 12 improves.

In some embodiments, the minimum distance between the circular end of the first rim 18a, 18b and the surface of the seat 15 remains substantially constant. That is, the minimum distance remains substantially constant along the entire circumference of the first rim 18a, 18b. In some embodiments, the minimum distance between the circular end of the first rim 18a, 18b and the surface of the seat 15 remains constant. That is, the minimum distance remains constant along the entire circumference of the first rim 18a, 18b. In some embodiments, the minimum distance between the circular end of the first, circular rim 18a, 18b and the surface of the seat 15 preferably remains substantially constant. That is, the minimum distance remains substantially constant along the entire circumference of the first, circular rim 18a, 18b. In some embodiments, the minimum distance between the circular end of the first, circular rim 18a, 18b and the surface of the seat 15 remains constant. That is, the minimum distance remains constant along the entire circumference of the first, circular rim 18a, 18b.

In some embodiments, an edge 18a, 18b such as a first, circular edge projects from the seat 15 and/or from the surface of the seat 15. The seat surface is smooth except for the first edge 18a, 18b projecting from the seat surface, the seat surface and the first edge 18a, 18b being unitary. More specifically, the seat surface is smooth except for the first, circular edge 18a, 18b projecting from the seat surface, the seat surface and the first, circular edge being unitary. The seat surface can be flat except for the first, circular edge 18a, 18b projecting from the seat surface.

In some embodiments, the first edge 18a, 18b is arranged in between the first flat portion 16a, 16b and the second flat portion 17a, 17b. The first edge 18a, 18b can also be arranged in between the first smooth portion 16a, 16b and the second smooth portion 17a, 17b. More specifically, the first, circular edge 18a, 18b is arranged in between the first flat portion 16a, 16b and the second flat portion 17a, 17b. The first, circular edge 18a, 18b can also be arranged in between the first smooth portion 16a, 16b and the second smooth portion 17a, 17b.

In some embodiments, the first edge 18a, 18b projecting from the surface of the seat 15 has rotational symmetry. In some embodiments, the first edge 18a, 18b and the flow control adaptor 14a, 14b and the head portion of the plunger 5 have rotational symmetry. The flow control adaptor 14a, 14b and the first edge 18a, 18b can exhibit rotational symmetry about substantially the same axis. The flow control adaptor 14a, 14b and the first edge 18a, 18b can even exhibit rotational symmetry about the same axis. The plunger 5 and the first edge 18a, 18b can exhibit rotational symmetry about substantially the same axis. The plunger 5 and the first edge 18a, 18b can even exhibit rotational symmetry about the same axis. These axes are defined by the linear movement of the plunger 5. These axes can also be defined by the axial movement of the plunger 5.

In some embodiments, the first edge 18a, 18b projects between 0.1 millimetres and 0.5 millimetres from the surface of the seat 15. That is, the first edge 18a, 18b has an end pointing toward the gasket 12. A minimum distance between the end of the first edge 18a, 18b and the surface of the seat 15 is between 0.1 millimetres and 0.5 millimetres. In some embodiments, the first edge 18a, 18b projects 0.2 millimetres or 0.3 millimetres from the surface of the seat 15. That is, the first edge 18a, 18b has an end pointing toward the gasket 12. A minimum distance between the end of the first edge 18a, 18b and the surface of the seat 15 is 0.2 millimetres or 0.3 millimetres. As the first edge 18a, 18b projects further from the surface of the seat 15, the retention of the gasket 12 improves.

In some embodiments, the minimum distance between the circular end of the first edge 18a, 18b and the surface of the seat 15 remains substantially constant. That is, the minimum distance remains substantially constant along the entire circumference of the first edge 18a, 18b. In some embodiments, the minimum distance between the circular end of the first edge 18a, 18b and the surface of the seat 15 remains constant. That is, the minimum distance remains constant along the entire circumference of the first edge 18a, 18b. In some embodiments, the minimum distance between the circular end of the first, circular edge 18a, 18b and the surface of the seat 15 remains substantially constant. That is, the minimum distance remains substantially constant along the entire circumference of the first, circular edge 18a, 18b. In some embodiments, the minimum distance between the circular end of the first, circular edge 18a, 18b and the surface of the seat 15 remains constant. That is, the minimum distance remains constant along the entire circumference of the first, circular edge 18a, 18b.

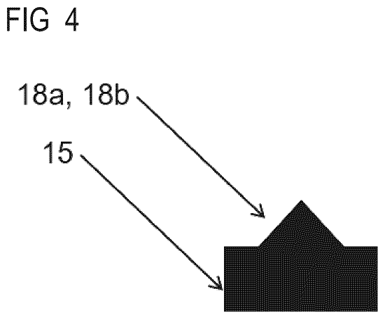

Now referring to FIG. 4, details of the first rim 18a, 18b are illustrated. The first rim 18a, 18b as shown in FIG. 4 projects from the seat 15 and/or from the surface of the seat 15. The first rim 18a, 18b has a circular end pointing toward the gasket 12 and the first rim 18a, 18b tapers toward its circular end. The first rim 18a, 18b tapers toward its circular end at an obtuse angle. The obtuse angle can, by way of non-limiting example, exceed 105° or be 120° or be less than 135°. The obtuse angle can, by way of another non-limiting example, be substantially 120°. The obtuse angle can be between 119° and 121°. The obtuse angle affords a valve 1 and a valve seat assembly 6 with fluid-tightness across the entire operational range of temperatures.

The first rim 18a, 18b as shown in FIG. 4 can be a first, circular rim 18a, 18b as explained above. The first, circular rim 18a, 18b projects from the seat 15 and from the surface of the seat 15. The first, circular rim 18a, 18b has a circular end pointing toward the gasket 12 and the first, circular rim 18a, 18b tapers toward its circular end.

The first, circular rim 18a, 18b tapers toward its circular end at an obtuse angle. The obtuse angle can, by way of non-limiting example, exceed 105° or be 120° or be less than 135°. The obtuse angle can, by way of another non-limiting example, be substantially 120°. The obtuse angle can be between 119° and 121°. The obtuse angle affords a valve 1 and a valve seat assembly 6 with fluid-tightness across the entire operational range of temperatures.

FIG. 4 also depicts details of a first edge 18a, 18b. The first edge 18a, 18b as shown in FIG. 4 projects from the seat 15 and/or from the surface of the seat 15. The first edge 18a, 18b has a circular end pointing toward the gasket 12 and the first edge 18a, 18b tapers toward its circular end.

The first edge 18a, 18b tapers toward its circular end at an obtuse angle. The obtuse angle can, by way of non-limiting example, exceed 105° or be 120° or be less than 135°. The obtuse angle can, by way of another non-limiting example, be substantially 120°. The obtuse angle can be between 119° and 121°. The obtuse angle affords a valve 1 and a valve seat assembly 6 with fluid-tightness across the entire operational range of temperatures.

The first edge 18a, 18b as shown in FIG. 4 can be a first, circular edge 18a, 18b as explained above. The first, circular edge 18a, 18b as shown in FIG. 4 projects from the seat 15 and from the surface of the seat 15. The first, circular edge 18a, 18b has a circular end pointing toward the gasket 12 and the first, circular edge 18a, 18b tapers toward its circular end.

The first, circular edge 18a, 18b tapers toward its circular end at an obtuse angle. The obtuse angle can, by way of non-limiting example, exceed 105° or be 120° or be less than 135°. The obtuse angle can, by way of another non-limiting example, be substantially 120°. The obtuse angle can be between 119° and 121°. The obtuse angle affords a valve 1 and a valve seat assembly 6 with fluid-tightness across the entire operational range of temperatures.

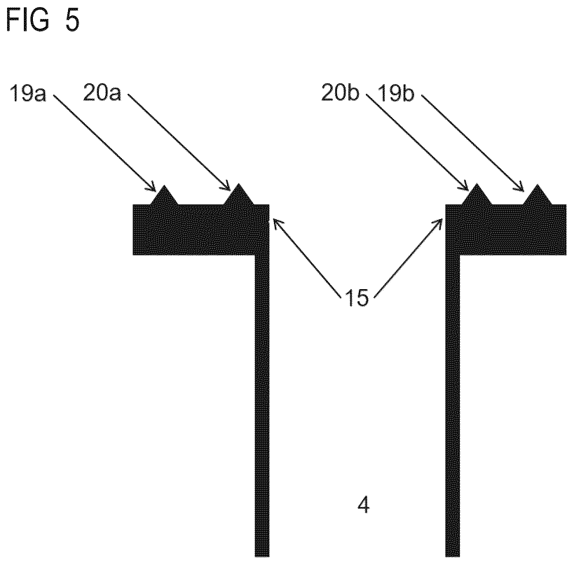

FIG. 5 shows a valve seat assembly 6 having more than one rim. A second rim 19a, 19b projects from the seat 15 and from the surface of the seat 15. In some embodiments, the second rim 19a, 19b comprises an outer rim 19a, 19b. In some embodiments, the second rim 19a, 19b is an outer rim 19a, 19b.

In some embodiments, the outer rim 19a, 19b projecting from the surface of the seat 15 has rotational symmetry. In some embodiments, the outer rim 19a, 19b and the flow control adaptor 14a, 14b and the head portion of the plunger 5 have rotational symmetry. The flow control adaptor 14a, 14b and the outer rim 19a, 19b can exhibit rotational symmetry about substantially the same axis. The flow control adaptor 14a, 14b and the outer rim 19a, 19b can even exhibit rotational symmetry about the same axis. The plunger 5 and the outer rim 19a, 19b can exhibit rotational symmetry about substantially the same axis. The plunger 5 and the outer rim 19a, 19b can even exhibit rotational symmetry about the same axis. These axes are defined by the linear movement of the plunger 5. These axes can also be defined by the axial movement of the plunger 5.

In some embodiments, the outer rim 19a, 19b projects between 0.1 millimetres and 0.5 millimetres from the surface of the seat 15. That is, the outer rim 19a, 19b has an end pointing toward the gasket 12. A minimum distance between the end of the outer rim 19a, 19b and the surface of the seat 15 is between 0.1 millimetres and 0.5 millimetres. In some embodiments, the outer rim 19a, 19b projects 0.2 millimetres or 0.3 millimetres from the surface of the seat 15. That is, the outer rim 19a, 19b has an end pointing toward the gasket 12. A minimum distance between the end of the outer rim 19a, 19b and the surface of the seat 15 is 0.2 millimetres or 0.3 millimetres. As the outer rim 19a, 19b projects further from the surface of the seat 15, the retention of the gasket 12 improves.

In some embodiments, the minimum distance between the circular end of the outer rim 19a, 19b and the surface of the seat 15 remains substantially constant. That is, the minimum distance remains substantially constant along the entire circumference of the outer rim 19a, 19b. In some embodiments, the minimum distance between the circular end of the outer rim 19a, 19b and the surface of the seat 15 remains constant. That is, the minimum distance remains constant along the entire circumference of the outer rim 19a, 19b.

The notes on the obtuse angle of the first rim 18a, 18b as shown in FIG. 4 apply to the outer rim 19a, 19b as shown in FIG. 5.

In some embodiments, the outer rim 19a, 19b can comprise an outer, circular rim 19a, 19b. More specifically, the outer rim 19a, 19b can be an outer, circular rim 19a, 19b. The outer, circular rim 19a, 19b projects from the seat 15 and/or projects from the surface of the seat 15 and has rotational symmetry. In some embodiments, the outer, circular rim 19a, 19b and the flow control adaptor 14a, 14b and the head portion of the plunger 5 have rotational symmetry. The flow control adaptor 14a, 14b and the outer, circular rim 19a, 19b can exhibit rotational symmetry about substantially the same axis. The flow control adaptor 14a, 14b and the outer, circular rim 19a, 19b can even exhibit rotational symmetry about the same axis. The plunger 5 and the outer, circular rim 19a, 19b can exhibit rotational symmetry about substantially the same axis. The plunger 5 and the outer, circular rim 19a, 19b can even exhibit rotational symmetry about the same axis. These axes are defined by the linear movement of the plunger 5. These axes can also be defined by the axial movement of the plunger 5.

In some embodiments, the outer, circular rim 19a, 19b projects between 0.1 millimetres and 0.5 millimetres from the surface of the seat 15. That is, the outer, circular rim 19a, 19b has an end pointing toward the gasket 12. A minimum distance between the end of the outer, circular rim 19a, 19b and the surface of the seat 15 is between 0.1 millimetres and 0.5 millimetres. In some embodiments, the outer, circular rim 19a, 19b projects 0.2 millimetres or 0.3 millimetres from the surface of the seat 15. That is, the outer, circular rim 19a, 19b has an end pointing toward the gasket 12. A minimum distance between the end of the outer, circular rim 19a, 19b and the surface of the seat 15 is 0.2 millimetres or 0.3 millimetres. As the outer, circular rim 19a, 19b projects further from the surface of the seat 15, the retention of the gasket 12 improves.

In some embodiments, the minimum distance between the circular end of the outer, circular rim 19a, 19b and the surface of the seat 15 remains substantially constant. That is, the minimum distance remains substantially constant along the entire circumference of the outer, circular rim 19a, 19b. In some embodiments, the minimum distance between the circular end of the outer, circular rim 19a, 19b and the surface of the seat 15 remains constant. That is, the minimum distance remains constant along the entire circumference of the outer, circular rim 19a, 19b.

The notes on the obtuse angle of the first rim 18a, 18b as shown in FIG. 4 apply to the outer, circular rim 19a, 19b as shown in FIG. 5.

In some embodiments, FIG. 5 shows a valve seat assembly 6 having more than one edge. A second edge 19a, 19b projects from the seat 15 and from the surface of the seat 15. In some embodiments, the second edge 19a, 19b comprises an outer edge 19a, 19b. In some embodiments, the second edge 19a, 19b is an outer edge 19a, 19b.

The second edge 19a, 19b projects from the seat 15 and projects from the surface of the seat 15 and has rotational symmetry. In some embodiments, the outer edge 19a, 19b and the flow control adaptor 14a, 14b and the head portion of the plunger 5 have rotational symmetry. The flow control adaptor 14a, 14b and the outer edge 19a, 19b can exhibit rotational symmetry about substantially the same axis. The flow control adaptor 14a, 14b and the outer edge 19a, 19b can even exhibit rotational symmetry about the same axis. The plunger 5 and the outer edge 19a, 19b can exhibit rotational symmetry about substantially the same axis. The plunger 5 and the outer edge 19a, 19b can even exhibit rotational symmetry about the same axis. These axes are defined by the linear movement of the plunger 5. These axes can also be defined by the axial movement of the plunger 5.

In some embodiments, the outer edge 19a, 19b projects between 0.1 millimetres and 0.5 millimetres from the surface of the seat 15. That is, the outer edge 19a, 19b has an end pointing toward the gasket 12. A minimum distance between the end of the outer edge 19a, 19b and the surface of the seat 15 is between 0.1 millimetres and 0.5 millimetres. In some embodiments, the outer edge 19a, 19b projects 0.2 millimetres or 0.3 millimetres from the surface of the seat 15. That is, the outer edge 19a, 19b has an end pointing toward the gasket 12. A minimum distance between the end of the outer edge 19a, 19b and the surface of the seat 15 is 0.2 millimetres or 0.3 millimetres. As the outer edge 19a, 19b projects further from the surface of the seat 15, the retention of the gasket 12 improves.

In some embodiments, the minimum distance between the circular end of the outer edge 19a, 19b and the surface of the seat 15 remains substantially constant. That is, the minimum distance remains substantially constant along the entire circumference of the outer edge 19a, 19b. In some embodiments, the minimum distance between the circular end of the outer edge 19a, 19b and the surface of the seat 15 remains constant. That is, the minimum distance remains constant along the entire circumference of the outer edge 19a, 19b.

The notes on the obtuse angle of the first edge 18a, 18b as shown in FIG. 4 apply to the outer edge 19a, 19b as shown in FIG. 5.

In some embodiments, the outer edge 19a, 19b can comprise an outer, circular edge 19a, 19b. More specifically, the outer edge 19a, 19b can be an outer, circular edge 19a, 19b. The outer, circular edge 19a, 19b projects from the seat 15 and/or projects from the surface of the seat 15 and has rotational symmetry. In some embodiments, the outer, circular edge 19a, 19b and the flow control adaptor 14a, 14b and the head portion of the plunger 5 have rotational symmetry. The flow control adaptor 14a, 14b and the outer, circular edge 19a, 19b can exhibit rotational symmetry about substantially the same axis. The flow control adaptor 14a, 14b and the outer, circular edge 19a, 19b can even exhibit rotational symmetry about the same axis. The plunger 5 and the outer, circular edge 19a, 19b can exhibit rotational symmetry about substantially the same axis. The plunger 5 and the outer, circular edge 19a, 19b can even exhibit rotational symmetry about the same axis. These axes are advantageously defined by the linear movement of the plunger 5. These axes can also be defined by the axial movement of the plunger 5.

In some embodiments, the outer, circular edge 19a, 19b projects between 0.1 millimetres and 0.5 millimetres from the surface of the seat 15. That is, the outer, circular edge 19a, 19b has an end pointing toward the gasket 12. A minimum distance between the end of the outer, circular edge 19a, 19b and the surface of the seat 15 is between 0.1 millimetres and 0.5 millimetres. It is still envisaged that the outer, circular edge 19a, 19b projects 0.2 millimetres or 0.3 millimetres from the surface of the seat 15. That is, the outer, circular edge 19a, 19b has an end pointing toward the gasket 12. A minimum distance between the end of the outer, circular edge 19a, 19b and the surface of the seat 15 is 0.2 millimetres or 0.3 millimetres. As the outer, circular edge 19a, 19b projects further from the surface of the seat 15, the retention of the gasket 12 improves.

In some embodiments, the minimum distance between the circular end of the outer, circular edge 19a, 19b and the surface of the seat 15 remains substantially constant. That is, the minimum distance remains substantially constant along the entire circumference of the outer, circular edge 19a, 19b. In some embodiments, the minimum distance between the circular end of the outer, circular edge 19a, 19b and the surface of the seat 15 remains constant. That is, the minimum distance remains constant along the entire circumference of the outer, circular edge 19a, 19b. The notes on the obtuse angle of the first edge 18a, 18b as shown in FIG. 4 apply to the outer, circular edge 19a, 19b as shown in FIG. 5.

FIG. 5 shows a valve seat assembly 6 having more than one rim. A third rim 20a, 20b projects from the seat 15 and from the surface of the seat 15. In some embodiments, the third rim 20a, 20b comprises an inner rim 20a, 20b. In some embodiments, the third rim 20a, 20b is an inner rim 20a, 20b. The third rim 20a, 20b is different from the second rim 19a, 19b. The third rim 20a, 20b is closer to the symmetry axis defined by the linear movement of the plunger 5 than the second rim 19a, 19b. The third rim 20a, 20b is also closer to the symmetry axis defined by the axial movement of the plunger 5 than the second rim 19a, 19b.

In some embodiments, the inner rim 20a, 20b projecting from the surface of the seat 15 has rotational symmetry. In some embodiments, the inner rim 20a, 20b and the flow control adaptor 14a, 14b and the head portion of the plunger 5 have rotational symmetry. In some embodiments, the outer rim 19a, 19b, the inner rim 20a, 20b, and the head portion of the plunger 5 have rotational symmetry. The flow control adaptor 14a, 14b and the inner rim 20a, 20b can exhibit rotational symmetry about substantially the same axis. The flow control adaptor 14a, 14b and the inner rim 20a, 20b can even exhibit rotational symmetry about the same axis. The plunger 5 and the inner rim 20a, 20b can exhibit rotational symmetry about substantially the same axis. The plunger 5 and the inner rim 20a, 20b can even exhibit rotational symmetry about the same axis. The outer rim 19a, 19b and the inner rim 20a, 20b can exhibit rotational symmetry about substantially the same axis. The outer rim 19a, 19b and the inner rim 20a, 20b can even exhibit rotational symmetry about the same axis. These axes are defined by the linear movement of the plunger 5. These axes can also be defined by the axial movement of the plunger 5.

In some embodiments, the inner rim 20a, 20b projects between 0.1 millimetres and 0.5 millimetres from the surface of the seat 15. That is, the inner rim 20a, 20b has an end pointing toward the gasket 12. A minimum distance between the end of the inner rim 20a, 20b and the surface of the seat 15 is between 0.1 millimetres and 0.5 millimetres. In some embodiments, the inner rim 20a, 20b projects 0.2 millimetres or 0.3 millimetres from the surface of the seat 15. That is, the inner rim 20a, 20b has an end pointing toward the gasket 12. A minimum distance between the end of the inner rim 20a, 20b and the surface of the seat 15 is 0.2 millimetres or 0.3 millimetres. As the inner rim 20a, 20b projects further from the surface of the seat 15, the retention of the gasket 12 improves.

In some embodiments, the minimum distance between the circular end of the inner rim 20a, 20b and the surface of the seat 15 remains substantially constant. That is, the minimum distance remains substantially constant along the entire circumference of the inner rim 20a, 20b. In some embodiments, the minimum distance between the circular end of the inner rim 20a, 20b and the surface of the seat 15 remains constant. That is, the minimum distance remains constant along the entire circumference of the inner rim 20a, 20b. The outer rim 19a, 19b and the inner rim 20a, 20b project from the surface of the seat 15 by substantially the same distance. In some embodiments, the outer rim 19a, 19b and the inner rim 20a, 20b project from the surface of the seat 15 by the same distance. The complexity of the valve seat assembly 6 is thereby reduced and manufacture of the valve seat assembly 6 is facilitated.

The notes on the obtuse angle of the first rim 18a, 18b as shown in FIG. 4 apply to the inner rim 20a, 20b as shown in FIG. 5. The outer rim 19a, 19b and the inner rim 20a, 20b each taper at substantially the same obtuse angle. In some embodiments, the outer rim 19a, 19b and the inner rim 20a, 20b each taper at the same obtuse angle. The complexity of the valve seat assembly 6 is thereby reduced and manufacture of the valve seat assembly 6 is facilitated.

In some embodiments, the inner rim 20a, 20b can comprise an inner, circular rim 20a, 20b. More specifically, the inner rim 20a, 20b can be an inner, circular rim 20a, 20b. The inner, circular rim 20a, 20b is different from the outer, circular rim 19a, 19b.

The inner, circular rim 20a, 20b projects from the seat 15 and/or projects from the surface of the seat 15 and has rotational symmetry. In some embodiments, the inner, circular rim 20a, 20b and the flow control adaptor 14a, 14b and the head portion of the plunger 5 have rotational symmetry. In some embodiments, the outer, circular rim 19a, 19b, the inner, circular rim 20a, 20b, and the head portion of the plunger 5 have rotational symmetry. The flow control adaptor 14a, 14b and the inner, circular rim 20a, 20b can exhibit rotational symmetry about substantially the same axis. The flow control adaptor 14a, 14b and the inner, circular rim 20a, 20b can even exhibit rotational symmetry about the same axis. The plunger 5 and the inner, circular rim 20a, 20b can exhibit rotational symmetry about substantially the same axis. The plunger 5 and the inner, circular rim 20a, 20b can even exhibit rotational symmetry about the same axis. The outer, circular rim 19a, 19b and the inner, circular rim 20a, 20b can exhibit rotational symmetry about substantially the same axis. The outer, circular rim 19a, 19b and the inner, circular rim 20a, 20b can even exhibit rotational symmetry about the same axis. These axes are defined by the linear movement of the plunger 5. These axes can also be defined by the axial movement of the plunger 5.

In some embodiments, the inner, circular rim 20a, 20b projects between 0.1 millimetres and 0.5 millimetres from the surface of the seat 15. That is, the inner, circular rim 20a, 20b has an end pointing toward the gasket 12. A minimum distance between the end of the inner, circular rim 20a, 20b and the surface of the seat 15 is between 0.1 millimetres and 0.5 millimetres. In some embodiments, the inner, circular rim 20a, 20b projects 0.2 millimetres or 0.3 millimetres from the surface of the seat 15. That is, the inner, circular rim 20a, 20b has an end pointing toward the gasket 12. A minimum distance between the end of the inner, circular rim 20a, 20b and the surface of the seat 15 is 0.2 millimetres or 0.3 millimetres. As the inner, circular rim 20a, 20b projects further from the surface of the seat 15, the retention of the gasket 12 improves.

In some embodiments, the minimum distance between the circular end of the inner, circular rim 20a, 20b and the surface of the seat 15 remains substantially constant. That is, the minimum distance remains substantially constant along the entire circumference of the inner, circular rim 20a, 20b. In some embodiments, the minimum distance between the circular end of the inner, circular rim 20a, 20b and the surface of the seat 15 remains constant. That is, the minimum distance remains constant along the entire circumference of the inner, circular rim 20a, 20b.

The outer, circular rim 19a, 19b and the inner, circular rim 20a, 20b project from the surface of the seat 15 by substantially the same distance. In some embodiments, the outer, circular rim 19a, 19b and the inner, circular rim 20a, 20b project from the surface of the seat 15 by the same distance. The complexity of the valve seat assembly 6 is thereby reduced and manufacture of the valve seat assembly 6 is facilitated. The notes on the obtuse angle of the first rim 18a, 18b as shown in FIG. 4 apply to the inner, circular rim 20a, 20b as shown in FIG. 5. The outer, circular rim 19a, 19b and the inner, circular rim 20a, 20b each taper at substantially the same obtuse angle. In some embodiments, the outer, circular rim 19a, 19b and the inner, circular rim 20a, 20b each taper at the same obtuse angle. The complexity of the valve seat assembly 6 is thereby reduced and manufacture of the valve seat assembly 6 is facilitated.

In some embodiments, FIG. 5 shows a valve seat assembly 6 having more than one edge. A third edge 20a, 20b projects from the seat 15 and from the surface of the seat 15. In some embodiments, the third edge 20a, 20b comprises an edge 20a, inner 20b. In some embodiments, the third edge 20a, 20b is an inner edge 20a, 20b. The third edge 20a, 20b is different from the second edge 19a, 19b. The third edge 20a, 20b is closer to the symmetry axis defined by the linear movement of the plunger 5 than the second edge 19a, 19b. The third edge 20a, 20b is also closer to the symmetry axis defined by the axial movement of the plunger 5 than the second edge 19a, 19b.

The third edge 20a, 20b projects from the seat 15 and/or projects from the surface of the seat 15 and has rotational symmetry. In some embodiments, the inner edge 20a, 20b and the flow control adaptor 14a, 14b and the head portion of the plunger 5 have rotational symmetry. In some embodiments, the outer edge 19a, 19b, the inner edge 20a, 20b, and the head portion of the plunger 5 have rotational symmetry. The flow control adaptor 14a, 14b and the inner edge 20a, 20b can exhibit rotational symmetry about substantially the same axis. The flow control adaptor 14a, 14b and the inner edge 20a, 20b can even exhibit rotational symmetry about the same axis. The plunger 5 and the inner edge 20a, 20b can exhibit rotational symmetry about substantially the same axis. The plunger 5 and the inner edge 20a, 20b can even exhibit rotational symmetry about the same axis. The outer edge 19a, 19b and the inner edge 20a, 20b can exhibit rotational symmetry about substantially the same axis. The outer edge 19a, 19b and the inner edge 20a, 20b can even exhibit rotational symmetry about the same axis. These axes are defined by the linear movement of the plunger 5. These axes can also be defined by the axial movement of the plunger 5.

In some embodiments, the inner edge 20a, 20b projects between 0.1 millimetres and 0.5 millimetres from the surface of the seat 15. That is, the inner edge 20a, 20b has an end pointing toward the gasket 12. A minimum distance between the end of the inner edge 20a, 20b and the surface of the seat 15 is between 0.1 millimetres and 0.5 millimetres. In some embodiments, the inner edge 20a, 20b projects 0.2 millimetres or 0.3 millimetres from the surface of the seat 15. That is, the inner edge 20a, 20b has an end pointing toward the gasket 12. A minimum distance between the end of the inner edge 20a, 20b and the surface of the seat 15 is 0.2 millimetres or 0.3 millimetres. As the inner edge 20a, 20b projects further from the surface of the seat 15, the retention of the gasket 12 improves.

In some embodiments, the minimum distance between the circular end of the inner edge 20a, 20b and the surface of the seat 15 remains substantially constant. That is, the minimum distance remains substantially constant along the entire circumference of the inner edge 20a, 20b. In some embodiments, the minimum distance between the circular end of the inner edge 20a, 20b and the surface of the seat 15 remains constant. That is, the minimum distance remains constant along the entire circumference of the inner edge 20a, 20b.

The outer edge 19a, 19b and the inner edge 20a, 20b project from the surface of the seat 15 by substantially the same distance. In some embodiments, the outer edge 19a, 19b and the inner edge 20a, 20b project from the surface of the seat 15 by the same distance. The complexity of the valve seat assembly 6 is thereby reduced and manufacture of the valve seat assembly 6 is facilitated. The notes on the obtuse angle of the first edge 18a, 18b as shown in FIG. 4 apply to the inner edge 20a, 20b as shown in FIG. 5. The outer edge 19a, 19b and the inner edge 20a, 20b each taper at substantially the same obtuse angle. In some embodiments, the outer edge 19a, 19b and the inner edge 20a, 20b each taper at the same obtuse angle. The complexity of the valve seat assembly 6 is thereby reduced and manufacture of the valve seat assembly 6 is facilitated.

In some embodiments, the inner edge 20a, 20b can comprise an inner, circular edge 20a, 20b. More specifically, the inner edge 20a, 20b can be an inner, circular edge 20a, 20b. The inner, circular edge 20a, 20b is different from the outer, circular edge 19a, 19b.

The inner, circular edge 20a, 20b projects from the seat 15 and/or projects from the surface of the seat 15 and has rotational symmetry. In some embodiments, the inner, circular edge 20a, 20b and the flow control adaptor 14a, 14b and the head portion of the plunger 5 have rotational symmetry. In some embodiments, the outer, circular edge 19a, 19b, the inner, circular edge 20a, 20b, and the head portion of the plunger 5 have rotational symmetry. The flow control adaptor 14a, 14b and the inner, circular edge 20a, 20b can exhibit rotational symmetry about substantially the same axis. The flow control adaptor 14a, 14b and the inner, circular edge 20a, 20b can even exhibit rotational symmetry about the same axis. The plunger 5 and the inner, circular edge 20a, 20b can exhibit rotational symmetry about substantially the same axis. The plunger 5 and the inner, circular edge 20a, 20b can even exhibit rotational symmetry about the same axis. The outer, circular edge 19a, 19b and the inner, circular edge 20a, 20b can exhibit rotational symmetry about substantially the same axis. The outer, circular edge 19a, 19b and the inner, circular edge 20a, 20b can even exhibit rotational symmetry about the same axis. These axes are defined by the linear movement of the plunger 5. These axes can also be defined by the axial movement of the plunger 5.

In some embodiments, the inner, circular edge 20a, 20b projects between 0.1 millimetres and 0.5 millimetres from the surface of the seat 15. That is, the inner, circular edge 20a, 20b has an end pointing toward the gasket 12. A minimum distance between the end of the inner, circular edge 20a, 20b and the surface of the seat 15 is between 0.1 millimetres and 0.5 millimetres. In some embodiments, the inner, circular edge 20a, 20b projects 0.2 millimetres or 0.3 millimetres from the surface of the seat 15. That is, the inner, circular edge 20a, 20b has an end pointing toward the gasket 12. A minimum distance between the end of the inner, circular edge 20a, 20b and the surface of the seat 15 is 0.2 millimetres or 0.3 millimetres. As the inner, circular edge 20a, 20b projects further from the surface of the seat 15, the retention of the gasket 12 improves.

In some embodiments, the minimum distance between the circular end of the inner, circular edge 20a, 20b and the surface of the seat 15 remains substantially constant. That is, the minimum distance remains substantially constant along the entire circumference of the inner, circular edge 20a, 20b. In some embodiments, the minimum distance between the circular end of the inner, circular edge 20a, 20b and the surface of the seat 15 remains constant. That is, the minimum distance remains constant along the entire circumference of the inner, circular edge 20a, 20b. The outer, circular edge 19a, 19b and the inner, circular edge 20a, 20b project from the surface of the seat 15 by substantially the same distance. In some embodiments, the outer, circular edge 19a, 19b and the inner, circular edge 20a, 20b project from the surface of the seat 15 by the same distance. The complexity of the valve seat assembly 6 is thereby reduced and manufacture of the valve seat assembly 6 is facilitated. The notes on the obtuse angle of the first edge 18a, 18b as shown in FIG. 4 apply to the inner, circular edge 20a, 20b as shown in FIG. 5. The outer, circular edge 19a, 19b and the inner, circular edge 20a, 20b each taper at substantially the same obtuse angle. In some embodiments, the outer, circular edge 19a, 19b and the inner, circular edge 20a, 20b each taper at the same obtuse angle. The complexity of the valve seat assembly 6 is thereby reduced and manufacture of the valve seat assembly 6 is facilitated.

In some embodiments, the plunger (5) is situated in the fluid path between the first port (3) and the second port (4), the plunger (5) being selectively and axially movable between the closed position which closes the fluid path between the first port (3) and the second port (4) and the open position which opens the fluid path between the first port (3) and the second port (4).

In some embodiments, the adaptor (14a-14e) comprises a flow control adaptor (14a-14e).

In some embodiments, the valve seat assembly (6) comprises the adaptor (14a-14e). In some embodiments, the plunger (5) comprises the adaptor (14a-14e).

In some embodiments, the gasket (12) is separate from the adaptor (14a-14e). In some embodiments, the gasket (12) is separable from the adaptor (14a-14e). The separation takes place non-destructively. That is, the mechanical structure of the valve is preserved.

The first aperture comprises a first bore. The second aperture comprises a second bore.

In some embodiments, the first diameter is bigger than the second diameter. In some embodiments, the first diameter is wider than the second diameter. The first diameter can, by way of non-limiting example, be at least 0.5 millimetres wider than the second diameter. The first diameter can, by way of another non-limiting example, be at least one millimetre wider than the second diameter. These widths are widths in a lateral direction. A lateral direction is defined by the (movement of the) plunger (5), the lateral direction being perpendicular to the (linear and/or axial movement of the) plunger (5).

In some embodiments, the at least one first protrusion (18a, 18b; 19a, 19b; 20a, 20b) comprises at least one of:
a first edge (18a, 18b; 19a, 19b; 20a, 20b), a first, annular edge (18a, 18b; 19a, 19b; 20a, 20b),
a first, circular edge (18a, 18b; 19a, 19b; 20a, 20b),
a first rim (18a, 18b; 19a, 19b; 20a, 20b),
a first, annular rim (18a, 18b; 19a, 19b; 20a, 20b),
a first, circular rim (18a, 18b; 19a, 19b; 20a, 20b).

In some embodiments, the at least one first protrusion (18a, 18b; 19a, 19b; 20a, 20b) is selected from:
a first edge (18a, 18b; 19a, 19b; 20a, 20b),
a first, annular edge (18a, 18b; 19a, 19b; 20a, 20b),
a first, circular edge (18a, 18b; 19a, 19b; 20a, 20b),
a first rim (18a, 18b; 19a, 19b; 20a, 20b),
a first, annular rim (18a, 18b; 19a, 19b; 20a, 20b),
a first, circular rim (18a, 18b; 19a, 19b; 20a, 20b).

In some embodiments, the at least one first protrusion (18a, 18b; 19a, 19b; 20a, 20b) projects at least 0.2 millimetres from the surface of the seat (15).

In some embodiments, the at least one first protrusion (18a, 18b; 19a, 19b; 20a, 20b) projects at least 0.3 millimetres from the surface of the seat (15).

In some embodiments, the at least one first protrusion (18a, 18b; 19a, 19b; 20a, 20b) projects at least 0.5 millimetres from the surface of the seat (15).

In some embodiments, the at least one first protrusion (18a, 18b; 19a, 19b; 20a, 20b) is formed in the surface of the seat (15).

In some embodiments, the at least one first protrusion (18a, 18b; 19a, 19b; 20a, 20b) comprises an end pointing toward the gasket (12); wherein the at least one first protrusion (18a, 18b; 19a, 19b; 20a, 20b) tapers toward its end at an obtuse angle; and wherein the obtuse angle is between 105° and 150°.

In some embodiments, the at least one first protrusion (18a, 18b; 19a, 19b; 20a, 20b) comprises an end pointing toward the gasket (12); wherein the at least one first protrusion (18a, 18b; 19a, 19b; 20a, 20b) tapers toward its end at an obtuse angle; and wherein the obtuse angle is between 115° and 130°.

In some embodiments, the at least one first protrusion (18a, 18b; 19a, 19b; 20a, 20b) comprises a circular end pointing toward the gasket (12); wherein the at least one first protrusion (18a, 18b; 19a, 19b; 20a, 20b) tapers toward its circular end at an obtuse angle; and wherein the obtuse angle is between 105° and 150°.

In some embodiments, the at least one first protrusion (18a, 18b; 19a, 19b; 20a, 20b) comprises a circular end pointing toward the gasket (12); wherein the at least one first protrusion (18a, 18b; 19a, 19b; 20a, 20b) tapers toward its circular end at an obtuse angle; and wherein the obtuse angle is between 115° and 125°.

In some embodiments, the surface of the seat (15) comprises a first portion (16a, 16b; 17a, 17b) and wherein the surface of the gasket (12) comprises a first portion; wherein the first portion (16a, 16b; 17a, 17b) of the surface of the seat (15) and the first portion of the surface of the gasket (12) are each substantially perpendicular to an axis defined by a linear movement of the plunger (5); and wherein the first portion (16a, 16b; 17a, 17b) of the surface of the seat (15) abuts the first portion of the surface of the gasket (12).

In some embodiments, the surface of the seat (15) comprises a first portion (16a, 16b; 17a, 17b) and wherein the surface of the gasket (12) comprises a first portion; wherein the first portion (16a, 16b; 17a, 17b) of the surface of the seat (15) and the first portion of the surface of the gasket (12) are each perpendicular to an axis defined by a linear movement of the plunger (5); and wherein the first portion (16a, 16b; 17a, 17b) of the surface of the seat (15) abuts the first portion of the surface of the gasket (12).

In some embodiments, the surface of the seat (15) comprises a first portion (16a, 16b; 17a, 17b) and wherein the surface of the gasket (12) a first portion; comprises wherein the first portion (16a, 16b; 17a, 17b) of the surface of the seat (15) and the first portion of the surface of the gasket (12) are each substantially perpendicular to an axis defined by the linear movement of the plunger (5); and wherein the first portion (16a, 16b; 17a, 17b) of the surface of the seat (15) abuts the first portion of the surface of the gasket (12).

In some embodiments, the surface of the seat (15) comprises a first portion (16a, 16b; 17a, 17b) and wherein the surface of the gasket (12) a comprises first portion; wherein the first portion (16a, 16b; 17a, 17b) of the surface of the seat (15) and the first portion of the surface of the gasket (12) are each perpendicular to an axis defined by the linear movement of the plunger (5); and wherein the first portion (16a, 16b; 17a, 17b) of the surface of the seat (15) abuts the first portion of the surface of the gasket (12).

The aforementioned first portions of surfaces can also be perpendicular or be substantially perpendicular to an or to the axis defined by an or by the axial movement of the plunger (5).

In some embodiments, the valves (1) further comprises a first portion (16a, 16b; 17a, 17b) of the surface of the seat (15) and a first portion of the surface of the gasket (12), wherein the first portion (16a, 16b; 17a, 17b) of the surface of the seat (15) is flat; and wherein the first portion of the surface of the gasket (12) is flat.

In some embodiments, the valve further comprises first portion (16a, 16b; 17a, 17b) of the surface of the seat (15) and a first portion of the surface of the gasket (12), wherein the first portion (16a, 16b; 17a, 17b) of the surface of the seat (15) is smooth; and wherein the first portion of the surface of the gasket (12) is smooth.

In some embodiments, the valve further comprises a first portion (16a, 16b; 17a, 17b) of the surface of the seat (15), wherein the first portion (16a, 16b; 17a, 17b) of the surface of the seat (15) is substantially parallel to the first portion of the surface of the gasket (12).

In some embodiments, the valve further comprises a first portion (16a, 16b; 17a, 17b) of the surface of the seat (15), wherein the first portion (16a, 16b; 17a, 17b) of the surface of the seat (15) is parallel to the first portion of the surface of the gasket (12).

In some embodiments, the surface of the seat (15) comprises a second portion (17a, 17b; 16a, 16b) and wherein the surface of the gasket (12) comprises a second portion; wherein the second portion (17a, 17b; 16a, 16b) of the surface of the seat (15) is different from the first portion (16a, 16b; 17a, 17b) of the surface of the seat (15); wherein the second portion of the surface of the gasket (12) is different from the first portion of the surface of the gasket (12); wherein the second portion (17a, 17b; 16a, 16b) of the surface of the seat (15) and the second portion of the surface of the gasket (12) are each substantially perpendicular to an or to the axis defined by a or by the linear movement of the plunger (5); and wherein the second portion (17a, 17b; 16a, 16b) of the surface of the seat (15) abuts the second portion of the surface of the gasket (12).

In some embodiments, the surface of the seat (15) comprises a second portion (17a, 17b; 16a, 16b) and wherein the surface of the gasket (12) comprises portion; wherein the second portion (17a, 17b; 16a, 16b) of the surface of the seat (15) is different from the first portion (16a, 16b; 17a, 17b) of the surface of the seat (15); wherein the second portion of the surface of the gasket (12) is different from the first portion of the surface of the gasket (12); wherein the second portion (17a, 17b; 16a, 16b) of the surface of the seat (15) and the second portion of the surface of the gasket (12) are each perpendicular to an or to the axis defined by a or by the linear movement of the plunger (5); and wherein the second portion (17a, 17b; 16a, 16b) of the surface of the seat (15) abuts the second portion of the surface of the gasket (12).

The aforementioned second portions of surfaces can also be perpendicular or be substantially perpendicular to an or to the axis defined by an or by the axial movement of the plunger (5).

In some embodiments, the valve further comprises a second portion (17a, 17b; 16a, 16b) of the surface of the seat (15) and a second portion of the surface of the gasket (12), wherein the second portion (17a, 17b; 16a, 16b) of the surface of the seat (15) is flat; and wherein the second portion of the surface of the gasket (12) is flat.

In some embodiments, the valve further comprises a second portion (17a, 17b; 16a, 16b) of the surface of the seat (15) and a second portion of the surface of the gasket (12), wherein the second portion (17a, 17b; 16a, 16b) of the surface of the seat (15) is smooth; and wherein the second portion of the surface of the gasket (12) is smooth.

In some embodiments, the valve further comprises a second portion (17a, 17b; 16a, 16b) of the surface of the seat (15), wherein the second portion (17a, 17b; 16a, 16b) of the surface of the seat (15) is substantially parallel to the second portion of the surface of the gasket (12).

In some embodiments, the valve further comprises a second portion (17a, 17b; 16a, 16b) of the surface of the seat (15), wherein the second portion (17a, 17b; 16a, 16b) of the surface of the seat (15) is parallel to the second portion of the surface of the gasket (12).

In some embodiments, the valve further comprises a first portion (16a, 16b; 17a, 17b) of the surface of the seat (15) and a second portion (17a, 17b; 16a, 16b) of the surface of the seat (15), wherein the at least one first protrusion (18a, 18b; 19a, 19b; 20a, 20b) is interposed between the first portion (16a, 16b; 17a, 17b) of the surface of the seat (15) and the second portion (17a, 17b; 16a, 16b) of the surface of the seat (15).

In some embodiments, the valve further comprises a first portion of the surface of the gasket (12) and a second portion of the surface of the gasket (12), wherein the at least one first protrusion (18a, 18b; 19a, 19b; 20a, 20b) is interposed between the first portion of the surface of the gasket (12) and the second portion of the surface of the gasket (12).

In some embodiments, the valve further comprises a first portion (16a, 16b; 17a, 17b) of the surface of the seat (15) and a second portion (17a, 17b; 16a, 16b) of the surface of the seat (15), wherein the at least one first protrusion (18a, 18b; 19a, 19b; 20a, 20b) and the first portion (16a, 16b; 17a, 17b) of the surface of the seat (15) and the second portion (17a, 17b; 16a, 16b) of the surface of the seat (15) have rotational symmetry about the axis defined by the linear movement of the plunger (5).

In some embodiments, the valve further comprises a first portion (16a, 16b; 17a, 17b) of the surface of the seat (15) and a second portion (17a, 17b; 16a, 16b) of the surface of the seat (15), wherein the at least one first protrusion (18a, 18b; 19a, 19b; 20a, 20b) and the first portion (16a, 16b; 17a, 17b) of the surface of the seat (15) and the second portion (17a, 17b; 16a, 16b) of the surface of the seat (15) and the first portion of the surface of the gasket (12) and the second portion of the surface of the gasket (12) have rotational symmetry about the axis defined by the linear movement of the plunger (5).

In some embodiments, the valve further comprises a first portion (16a, 16b; 17a, 17b) of the surface of the seat (15) and a second portion (17a, 17b; 16a, 16b) of the surface of the seat (15), wherein the first portion (16a, 16b; 17a, 17b) of the surface of the seat (15) and the first portion of the surface of the gasket (12) and the second portion (17a, 17b; 16a, 16b) of the surface of the seat (15) and the second portion of the surface of the gasket (12) are substantially parallel to one another.

In some embodiments, the valve further comprises first portion (16a, 16b; 17a, 17b) of the surface of the seat (15) and a second portion (17a, 17b; 16a, 16b) of the surface of the seat (15), wherein the first portion (16a, 16b; 17a, 17b) of the surface of the seat (15) and the first portion of the surface of the gasket (12) and the second portion (17a, 17b; 16a, 16b) of the surface of the seat (15) and the second portion of the surface of the gasket (12) are parallel to one another.

In some embodiments, at least one second protrusion (19a, 19b; 20a, 20b) projects from the seat surface and imbeds itself into the gasket (12); and wherein the at least one second protrusion (19a, 19b; 20a, 20b) is different from the at least one first protrusion (18a, 18b; 19a, 19b; 20a, 20b).

In some embodiments, the at least one second protrusion (19a, 19b; 20a, 20b) is selected from:
a second edge (19a, 19b; 20a, 20b),
a second, annular edge (19a, 19b; 20a, 20b),
a second, circular edge (19a, 19b; 20a, 20b),
a second rim (19a, 19b; 20a, 20b),
a second, annular rim (19a, 19b; 20a, 20b),
a second, circular rim (19a, 19b; 20a, 20b).

In some embodiments, the at least one second protrusion (19a, 19b; 20a, 20b) is formed in the surface of the seat (15). In some embodiments, the at least one second protrusion (19a, 19b; 20a, 20b) projects at least 0.2 millimetres from the surface of the seat (15).

It is stressed that the foregoing relates only to certain embodiments of the disclosure. Numerous changes can be made therein without departing from the scope of the disclosure as defined by the following claims. It should also be understood that the disclosure is not restricted to the illustrated embodiments. Various modifications can be made within the scope of the following claims.

### REFERENCE NUMERALS

1 valve
2 housing
3 port
4 port
5 plunger
6 valve seat assembly
7 armature
8 stem
9a, 9b solenoid
10 chamber
11 resilient member
12 gasket
13 frame
14a-14e adaptors such as flow control adaptors
15 seat
16a, 16b surface such as seat surface
17a, 17b surface such as seat surface
18a, 18b protrusion, edge, rim
19a, 19b protrusion, edge, rim
20a, 20b protrusion, edge, rim

1. A valve comprising:
an adaptor;
a first port;
a second port;
a fluid path extending between the first port and the second port;
a plunger situated in the fluid path between the first port and the second port, the plunger selectively and linearly movable between a closed position blocking the fluid path and an open position;
a valve seat assembly in the fluid path, the valve seat assembly comprising: a gasket and a frame having a seat;
wherein the gasket is separate from the adaptor and the seat and is interposed between the adaptor and the seat (15);
wherein the adaptor has a first aperture having a first diameter and wherein the gasket has a second aperture having a second diameter;
wherein the first diameter is larger than the second diameter;
wherein in the open position the plunger is detached from the gasket to enable a flow of a fluid through the second aperture and along the fluid path;
wherein in the closed position the plunger abuts the gasket to prevent the flow of the fluid through the second aperture and along the fluid path;
wherein the seat comprises a seat surface; and
wherein a protrusion projects from the seat surface and imbeds itself into the gasket.

2. The valve according to claim 1, wherein the first protrusion comprises at least one of: an edge, an annular edge, a circular edge, a rim, an annular rim, and a circular rim.

3. The valve according to claim 1, wherein the protrusion projects at least 0.2 millimetres from the surface of the seat.

4. The valve according to claim 1, wherein the protrusion is formed in the surface of the seat.

5. The valve according to claim 1, wherein:
the protrusion comprises an end pointing toward the gasket;
the protrusion tapers toward the end at an obtuse angle; and
the obtuse angle is between 105° and 150°.

6. The valve according to claim 1, wherein:
a first portion of the surface of the seat and a first portion of the surface of the gasket are each substantially perpendicular to an axis defined by linear movement of the plunger; and
the first portion of the surface of the seat abuts the first portion of the surface of the gasket.

7. The valve according to claim 6, wherein:
the first portion of the surface of the seat is flat; and
wherein the first portion of the surface of the gasket is flat.

8. The valve according to claim 6, wherein the first portion of the surface of the seat is substantially parallel to the first portion of the surface of the gasket.

9. The valve according to claim 6, wherein:
a second portion of the surface of the seat is different from the first portion of the surface of the seat;
a second portion of the surface of the gasket is different from the first portion of the surface of the gasket;
the second portion of the surface of the seat and the second portion of the surface of the gasket are each substantially perpendicular to the axis; and
the second portion of the surface of the seat abuts the second portion of the surface of the gasket.

10. The valve according to claim 9, wherein:
the second portion of the surface of the seat is flat; and
wherein the second portion of the surface of the gasket is flat.

11. The valve according to claim 9, wherein the second portion of the surface of the seat is substantially parallel to the second portion of the surface of the gasket.

12. The valve according to claim 9, wherein the protrusion is interposed between the first portion of the surface of the seat and the second portion of the surface of the seat.

13. The valve according to claim 9, wherein the protrusion and the first portion of the surface of the seat and the second portion of the surface of the seat have rotational symmetry about the axis.

14. The valve according to claim 9, wherein the first portion of the surface of the seat and the first portion of the surface of the gasket and the second portion of the surface of the seat and the second portion of the surface of the gasket (12) are substantially parallel to one another.

15. The valve according to claim 1, wherein:
a second protrusion projects from the seat surface and imbeds itself into the gasket; and
the second protrusion is different from the protrusion.
